(19) United States
(12) Patent Application Publication
(10) Pub. No.: US 2012/0327220 A1
(43) Pub. Date: Dec. 27, 2012

(54) MULTI-VIEW ALIGNMENT BASED ON FIXED-SCALE GROUND PLANE RECTIFICATION

(75) Inventor: Zhonghua Ma, Petaluma, CA (US)

(73) Assignee: CANON KABUSHIKI KAISHA, Tokyo (JP)

(21) Appl. No.: 13/482,739

(22) Filed: May 29, 2012

(30) Foreign Application Priority Data
May 31, 2011 (AU) 2011202555

(51) Int. Cl. H04N 7/18

(52) U.S. Cl. 348/135; 348/E07.085

(57) ABSTRACT

A system and method of generating a common ground plane from a plurality of image sequences includes detecting at least three observations for each image sequence, generating a plurality of rectified ground planes for the plurality of image sequences, determining a geometric property of the plurality of observations in the plurality of image sequences, determining a relative scaling factor of each of the plurality of rectified ground planes, and generating the common ground plane from the plurality of image sequences based on the rectified ground planes and the determined relative scaling factors.

### CROSS-REFERENCES TO RELATED APPLICATIONS

This application claims the benefit under 35 U.S.C. §119 of the filing date of Australian Patent Application No. 2011202555, filed May 31, 2011, hereby incorporated by reference in its entirety as if fully set forth herein.

### TECHNICAL FIELD

The present disclosure relates generally to video processing and, in particular, to the alignment of multiple disjoint field of views for a multi-camera video surveillance system.

### DESCRIPTION OF BACKGROUND ART

Video cameras, such as Pan-Tilt-Zoom (PTZ) cameras, are omnipresent nowadays, and are commonly used for surveillance purposes. The cameras capture more data (video content) than human viewers can process. Automatic analysis of video content is therefore needed. When multiple cameras are used to monitor a large site, it is desirable to automate the recovery of the three-dimensional (3D) position and orientation of the camera in the environment, and model the activities of moving objects in the scene in world coordinate system.

The term multi-view alignment refers to the process of transforming fields of view (FOV) of different cameras into a common coordinate system.

Multi-view alignment is an important step in a multi-camera object tracking system with disjoint FOVs. That is, the fields of view of the cameras in the system do not overlap and are thus disjoint. Multi-view alignment integrates multiple two dimensional (2D) track information into a common coordinate system, thus enabling 3D track construction and high-level interpretations of the behaviours and events in the scene.

For a multi-camera object tracking system with disjoint FOVs, the process of multi-view alignment includes the following main steps:
1) rectifying the ground plane (on which the 'ted objects stand) in each FOV to a metric space, using either a homography or another projective transform;
2) estimating the relative rotation and translations between the ground planes of two FOVs, based on transit time or track connectivity; and
3) aligning the rectified ground planes to each other, based on relative rotations and translations among disjoint FOVs.

One method rectifies the ground plane in each FOV based on scene geometry identified through user interaction. The method first identifies multiple pairs of lines on the ground plane, where each pair of lines is parallel in the real world. The method then derives a horizon line in the image plane of each FOV, based on the intersection of multiple pairs of lines identified so far. The method further identifies multiple circular constraints on the ground plane. Such circular constraints may include, for example, a known angle between two non-parallel lines, or a known length ratio between two non-parallel lines. Based on the horizon and the circular constraints, the ground plane in each FOV is then transformed to a metric coordinate system using a homographic transform. However, a rectified ground plane generated using this method has an unknown rotation, scaling, and translation relative to the real ground plane. Hence, additional reference measures on the ground plane are needed when aligning multiple rectified ground planes to each other.

Another method rectifies the ground plane of each FOV based on a known camera intrinsic matrix and camera projective geometry. The camera intrinsic matrix is a 3×3 matrix comprising internal parameters of a camera, such as focal length, pixel aspect ratio, and principal point. The camera projective geometry includes information such as the location of the ground plane in the world coordinate system, the location of the camera above the ground, and the relative angle between the camera and the ground plane. The known camera intrinsic matrix and projective geometry are used to form a homographic transform, which brings the ground plane in the FOV of the camera to an overhead view, thus generating a metric-rectified version of the ground plane. This method was designed for calibrated cameras only. The method needs full knowledge of the internal parameters of the camera and the ground plane position in the image coordinate system, and hence configuration of the multi-camera system is time consuming. Moreover, the overhead view generated by the method is only accurate up to a scale factor to the real world and so further reference measures are needed to determine the relative scale of multiple rectified ground planes.

Yet another method derives a homographic transform that brings the ground plane to a metric-rectified position based on the pose and the velocity of moving objects on the ground plane. The method assumes that the height of an object stays roughly the same over the image frames. Therefore, given two observations in successive frames of the same object, the lines that connect the head and feet of the object over the observations, respectively, should be parallel to each other in the world coordinate system and the intersection of those connecting lines is on the horizon. Using the information of the horizon brings the ground plane in the image coordinate system to affine space. Under the assumption that the objects move on the ground plane at a constant speed, a set of linear constant-speed paths are identified and used to construct the circular constraints. Based on the circular constraints, the ground plane can be transformed from affine space to metric space. The method does not need any user interaction and camera calibration. However, the majority of the moving objects in practical applications frequently violate the assumption of constant velocity.

Therefore, there is a need for a multi-camera object tracking system to align object trajectories in disjoint FOVs automatically, without the disadvantages of existing multi-view alignment methods.

### SUMMARY

It is an object of the present disclosure to overcome substantially, or at least ameliorate, one or more disadvantages of existing arrangements.

According to a first aspect of the present disclosure, there is provided a method of generating a common ground plane from a plurality of image sequences, wherein each image sequence is captured by a corresponding one of a plurality of cameras. The plurality of cameras have disjoint fields of view of a scene. The method detects at least three observations for each image sequence and generates a plurality of rectified ground planes for the plurality of image sequences. The generation is based on a scene geometry and a spatial property of each corresponding camera determined from said detected observations in each of the image sequences. A geometric property of the plurality of observations in the plurality of image sequences is determined. The method determines a relative scaling factor of each of said plurality of rectified ground planes, the relative scaling factor being based on the geometric property of the plurality of objects in the images and the spatial property of each camera. The method then generates the common ground plane from the plurality of image sequences based on said rectified ground planes and said determined relative scaling factors.

According to a second aspect of the present disclosure, there is provided a computer readable storage medium having recorded thereon a computer program for directing a processor to execute a method of generating a common ground plane from a plurality of image sequences. Each image sequence is captured by a corresponding one of a plurality of cameras, wherein the plurality of cameras have disjoint fields of view of a scene. The computer program includes code for performing the steps of:

detecting at least three observations for each image sequence;

generating a plurality of rectified ground planes for the plurality of image sequences, said generation being based on a scene geometry and a spatial property of each is corresponding camera determined from said detected observations in each of the image sequences;

determining a geometric property of the plurality of observations in the plurality of image sequences;

determining a relative scaling factor of each of said plurality of rectified ground planes, said relative scaling factor based on the geometric property of the plurality of objects in the images and the spatial property associated with each camera; and

generating the common ground place from the plurality of image sequences based on said rectified ground planes and said determined relative scaling factors.

According to a third aspect of the present disclosure, there is provided a multi-camera system. The multi-camera system includes: a plurality of cameras having disjoint fields of view of a scene, each camera having a lens system, an associated sensor, and a control module for controlling the lens system and the sensor to capture an image of the scene; a storage device for storing a computer program; and a processor for executing the program. The program includes computer program code for generating a common ground plane from a plurality of image sequences captured by the plurality of cameras, each image sequence derived from one of the plurality of cameras. Generation of the common ground plane includes the steps of: detecting at least three observations for each image sequence; generating a plurality of rectified ground planes for the plurality of image sequences, said generation being based on a scene geometry and a spatial property of each corresponding camera determined from said detected observations in each of the image sequences; determining a geometric property of the plurality of observations in the plurality of image sequences; determining a relative scaling factor of each of said plurality of rectified ground planes, said relative scaling factor based on the geometric property of the plurality of objects in the images and the spatial property associated with each camera; and generating the common ground plane from the plurality of image sequences based on said rectified ground planes and said determined relative scaling factors.

According to a fourth aspect of the present disclosure, there is provided a multi-camera system including a plurality of cameras and a computer server coupled to each of the cameras. The plurality of cameras have disjoint fields of view of a scene, each camera having a lens system, an associated sensor, and a control module for controlling said lens system and said sensor to capture a respective image sequence of said scene. The server includes a storage device for storing a computer program and a processor for executing the program. The program includes computer program code for generating a common ground plane from a plurality of image sequences captured by said plurality of cameras, each image sequence derived from one of said plurality of cameras, the generating including the steps of: detecting at least three observations for each image sequence; generating a plurality of rectified ground planes for the plurality of image sequences, said generation being based on a scene geometry and a spatial property of each corresponding camera determined from said detected observations in each of the image sequences; determining a geometric property of the plurality of observations in the plurality of image sequences; determining a relative scaling factor of each of said plurality of rectified ground planes, said relative scaling factor based on the geometric property of the plurality of objects in the images and the spatial property associated with each camera; and generating the common ground plane from the plurality of image sequences based on said rectified ground planes and said determined relative scaling factors.

According to another aspect of the present disclosure, there is provided an apparatus for implementing any one of the aforementioned methods.

According to another aspect of the present disclosure, there is provided a computer program product including a computer readable medium having recorded thereon a computer program for implementing any one of the methods described above.

Other aspects of the invention are also disclosed.

### BRIEF DESCRIPTION OF THE DRAWINGS

One or more embodiments of the present disclosure will now be described with reference to the following drawings, in which:

FIG. 1 is a flow diagram illustrating functionality of an existing multi-camera object tracking system;

FIG. 2 is a schematic representation illustrating the projective geometry of an exemplary object tracking scenario in accordance with the present disclosure;

FIG. 3 is a flow diagram illustrating functionality of a method of multi-view alignment in accordance with the present disclosure;

FIG. 4 is a flow diagram of a horizon estimation process based on moving objects on the ground plane;

FIG. 5 is a flow diagram of a vertical vanishing point estimation process based on moving objects on the ground plane;

FIG. 6A is a flow diagram of a camera roll and tile estimation process.

FIG. 6B shows an example image plane with a horizon line;

FIG. 6C shows a side view of a pinhole camera model used for camera tilt estimation;

FIG. 7 is a schematic representation illustrating a side view of the geometric relationship between an unrectified camera coordinate system and a rectified camera coordinated system;

FIG. 8 is a flow diagram illustrating a relative scale adjustment process performed between two rectified ground planes;

FIG. 9 is a flow diagram illustrating a track interpolation process in accordance with the present disclosure;

FIG. 10 is a schematic block diagram representation of a network camera, upon which alignment may be performed;

FIG. 11 shows an electronic system suitable for implementing one or more embodiments of the present disclosure;

FIG. 12 is a block diagram illustrating a multi-camera system upon which embodiments of the present disclosure may be practised;

FIGS. 13A and 13B collectively form a schematic block diagram of a general purpose computing system in which the arrangements to be described may be implemented; and

FIGS. 14A and 14B are schematic representations of a scenario showing a person moving through a scene over multiple frames, from which the horizon line is estimated.

FIG. 15 shows an example of the linear relationship between an object position in the image and height of the object in the image.

### DETAILED DESCRIPTION

Where reference is made in any one or more of the accompanying drawings to steps and/or features that have the same reference numerals, those steps and/or features have for the purposes of this description the same function(s) or operation(s), unless the contrary intention appears.

Disclosed herein are a method and system for generating a common ground plane from image sequences derived from multiple cameras having disjoint fields of view. The method uses information derived from an image sequence captured by each camera to rectify a ground plane for each camera. Each image sequence includes at least two image frames. The image sequence includes at least a single detection in three frames of the image sequence or multiple detections in at least two frames of the image sequence. A detection, also known as an observation, corresponds to a detected object in a frame of an image sequence. The method then determines a statistical geometric property of the objects detected in the image sequences and uses that statistical geometric property to determine relative scaling factors of the common ground plane relative to each of the rectified ground planes. The common ground plane may be utilised in multi-camera surveillance systems. The method of the present disclosure transforms the respective disjoint fields of view of multiple cameras to produce a common overhead view without performing camera calibration. The common overhead view can then be utilised, for example, to determine whether a first object in a first field of view is the same as a second object in a second field of view.

Embodiments of the present disclosure operate on image sequences derived from a plurality of cameras, wherein the fields of view of the cameras are disjoint. That is, the fields of view of the cameras do not overlap. The cameras may be of the same or different types. The cameras may have the same or different focal lengths. The cameras may have the same or different heights relative to a ground plane of the scene that is being monitored. Embodiments of the present disclosure may be performed in real-time or near real-time, in which images captured in a multi-camera system are processed on the cameras, or on one or more computing devices coupled to the multi-camera system, or a combination thereof. Alternatively, embodiments of the present disclosure may equally be practised on a video analysis system some time after the images are captured by the camera. Processing of the images may be performed on one or more of the cameras in the multi-camera system, or on one or more computing devices, or a combination thereof. In one embodiment, processing of the images in accordance with the present disclosure is performed on a video analysis system that includes a computing device that retrieves from a storage medium a set of images captured by each camera in the multi-camera system that is under consideration.

One aspect of the present disclosure provides a method of generating a common ground plane from a plurality of image sequences. Each image sequence is captured by a corresponding one of a plurality of cameras, wherein the plurality of cameras has disjoint fields of view of a scene. The image sequence may have been captured contemporaneously or at different points of time. The method detects at least three observations for each image sequence. Each observation is a detected object. The method then determines a scene geometry for each camera, based on the detected observations in the image sequence corresponding to the camera. Then, the method determines a spatial property of each camera, based on the scene geometry for each respective camera. The method rectifies each of the image sequences to generate a plurality of rectified ground planes. The rectification is based on the scene geometry and the spatial property of each corresponding camera. The method determines a statistical geometric property of the plurality of observations in the plurality of image sequences and determines relative scaling factors of a common ground plane relative to each of the plurality of rectified ground planes. The relative scaling factor is based on the statistical geometric property of the plurality of objects in the images and the spatial property associated with each camera. The method then generates the common ground plane from the plurality of image sequences, based on the rectified ground planes and the determined relative scaling factors.

Some embodiments of the present disclosure then generate an overhead perspective view of the scene, based on the determined relative scaling factors of the ground plane.

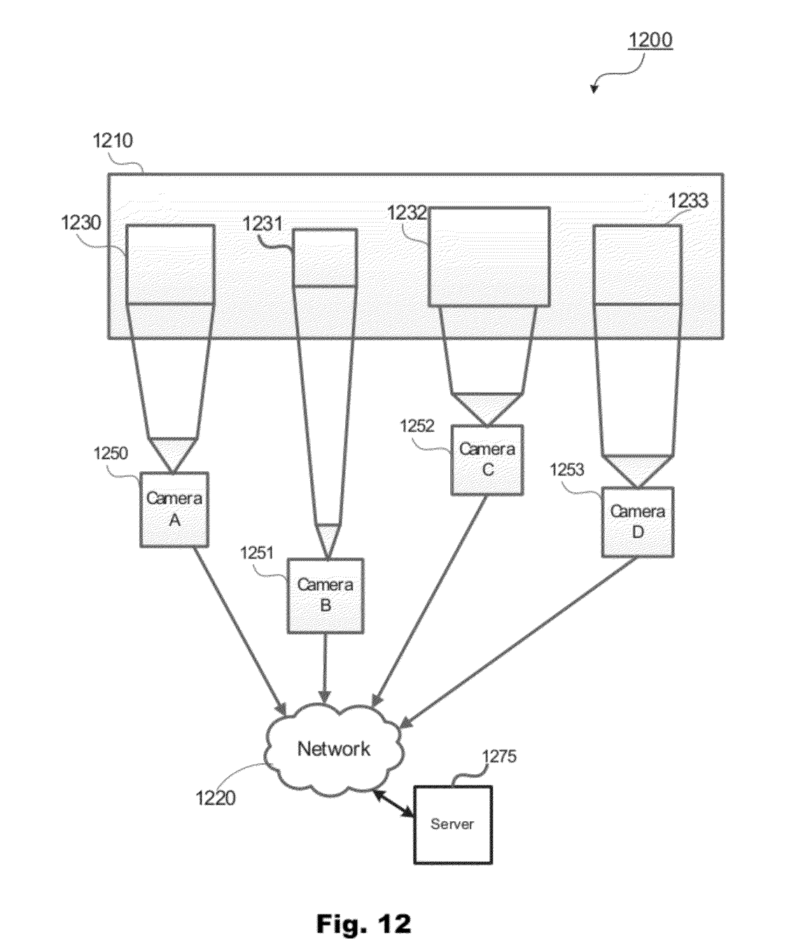

FIG. 12 is a schematic representation of a multi-camera system 1200 on which embodiments of the present disclosure may be practised. The multi-camera system 1200 includes a scene 1210, which is the complete scene that is being monitored or placed under surveillance. In the example of FIG. 12, the multi-camera system 1200 includes four cameras with disjoint fields of view: camera A 1250, camera B 1251, camera C 1252, and camera D 1253. In one example, the scene 1210 is a car park and the four cameras 1250, 1251, 1252, and 1253 form a surveillance system used to monitor different areas of the car park. The disjoint fields of view of the four cameras 1250, 1251, 1252, and 1253 may, for example, correspond to points of entry and egress. This may be useful when the multi-camera system 1200 is used to monitor people entering and leaving an area under surveillance.

Each of camera A 1250, camera B 1251, camera C 1252, and camera D 1253 is coupled to a computer server 1275 via a network 1220. The network 1120 may be implemented using one or more wired or wireless connections and may include a dedicated communications link, a Local Area Network (LAN), a Wide Area Network (WAN), the Internet, or any combination thereof. In an alternative implementation, not illustrated, camera A 1250, camera B 1251, camera C 1252, and camera D 1253 are coupled to the server 1275 using direct communications links.

Camera A 1250 has a first field of view looking at a first portion 1230 of the scene 1210 using PTZ coordinates PTZ_{A-1230}. PTZ_{A-1230} represents the PTZ coordinates of camera A 1250 looking at the first portion 1230 of the scene 1210. Camera B 1251 has a second field of view looking at a second portion 1231 of the scene 1210 using PTZ coordinates PTZ_{B-1231}, camera C 1252 has a third field of view looking at a third portion 1232 of the scene 1210 using PTZ coordinates PTZ_{C-1232}, and camera D 1254 has a fourth field of view looking at a fourth portion 1233 of the scene 1210 using PTZ coordinates PTZ_{D-1233}. As indicated above, the cameras in the multi-camera system 1200 have disjoint fields of view, and thus the first portion 1230, the second portion 1231, the third portion 1232, and the fourth portion 1233 of the scene 1210 have no overlapping sub-portions. In the example of FIG. 12, each of camera A 1250, camera B, 1251, camera C 1252, and camera D 1253 has a different focal length and is located at a different distance from the scene 1210. In other embodiments, two or more of camera A 1250, camera B, 1251, camera C 1252, and camera D 1253 are implemented using the same camera types with the same focal lengths and located at the same or different distances from the scene 1210.

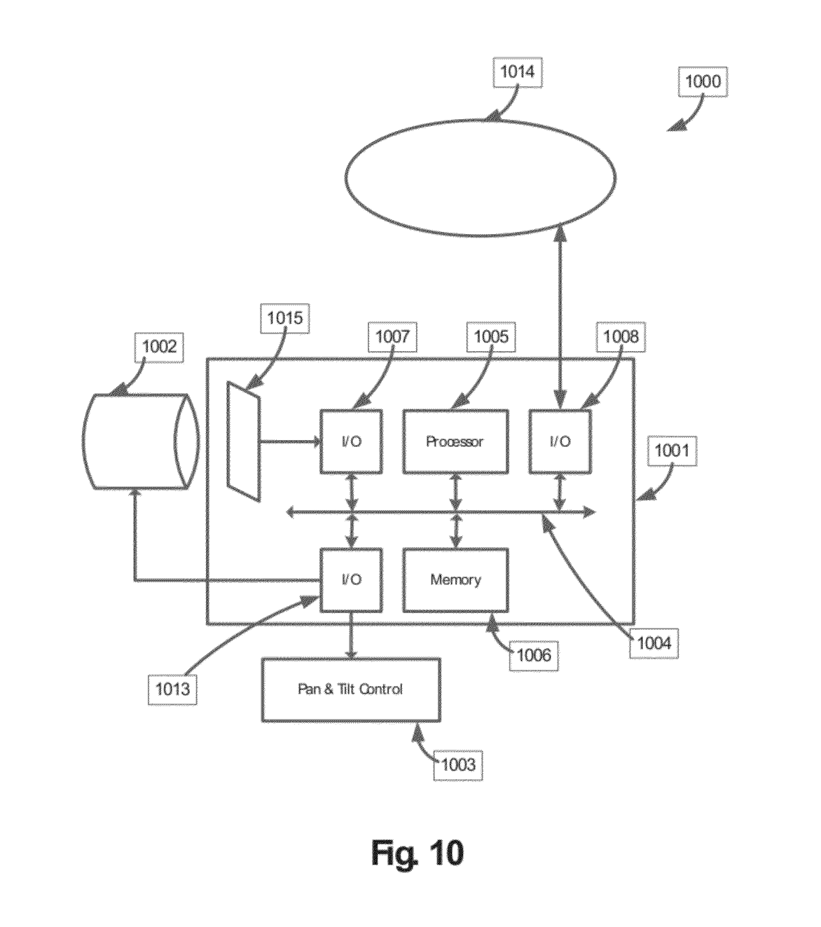

FIG. 10 shows a functional block diagram of a network camera 1000, upon which alignment may be performed. The camera 1000 is a pan-tilt-zoom camera (PTZ) comprising a camera module 1001, a pan and tilt module 1003, and a lens system 1002. The camera module 1001 typically includes at least one processor unit 1005, a memory unit 1006, a photo-sensitive sensor array 1015, an input/output (I/O) interface 1007 that couples to the sensor array 1015, an input/output (I/O) interface 1008 that couples to a communications network 1014, and an interface 1013 for the pan and tilt module 1003 and the lens system 1002. The components 1007, 1005, 1008, 1013 and 1006 of the camera module 1001 typically communicate via an interconnected bus 1004 and in a manner which results in a conventional mode of operation known to those skilled in the relevant art. Each of the four cameras 1250, 1251, 1252, and 1253 in the multi-camera system 1200 of FIG. 12 may be implemented using an instance of the network camera 1000.

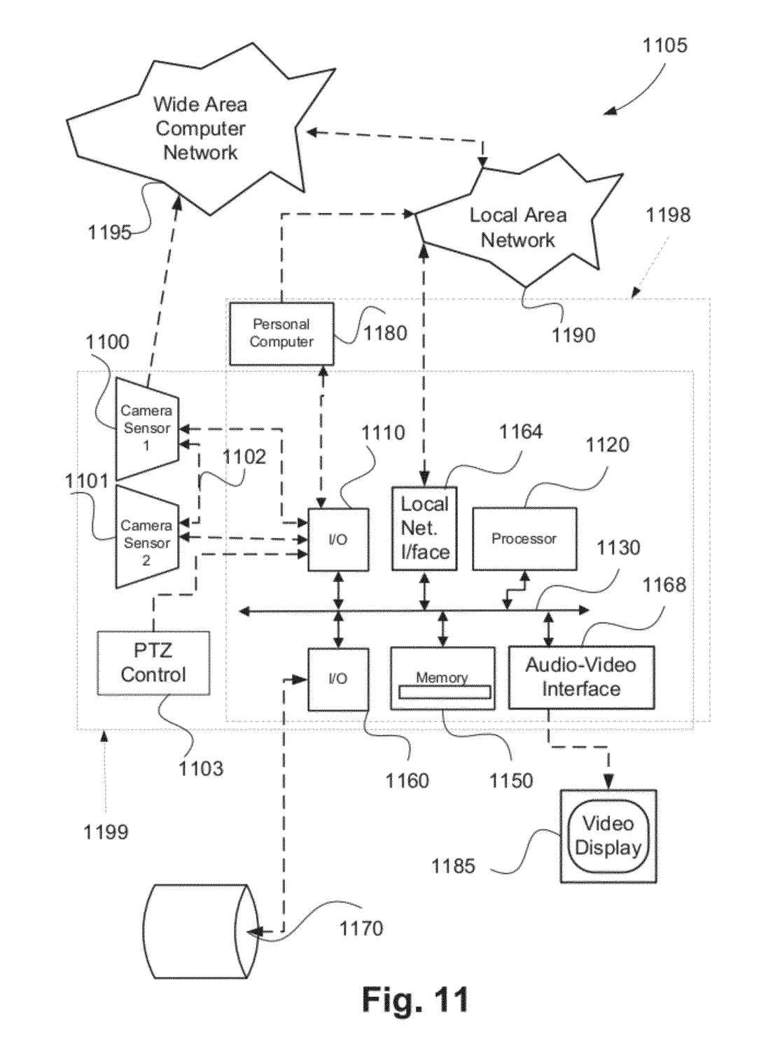

FIG. 11 shows an electronic system 1105 for effecting the disclosed multi-camera alignment method. Sensors 1100 and 1101 are used to obtain the images of the image sequence. Each sensor may represent a stand alone sensor device (i.e., a detector or a security camera) or be part of an imaging device, such as a camera, a mobile phone, etc. In one implementation, the electronic system 1105 is a camera system and each sensor 1100 and 1101 includes a lens system and an associated camera module coupled to the lens system, wherein the camera module stores images captured by the lens system. In one arrangement, the pan and tilt angles and the zoom of each sensor are controlled by a pan-tilt-zoom controller 1103. The remaining electronic elements 1110 to 1168 may also be part of the imaging device comprising sensors 1100 and 1101, as indicated by dotted line 1199. The electronic elements 1110 to 1168 may also be part of a computer system that is located either locally or remotely with respect to sensors 1100 and 1101. In the case indicated by dotted line 1198, electronic elements form a part of a personal computer 1180.

The transmission of the images from the sensors 1100 and 1101 to the processing electronics 1120 to 1168 is facilitated by an input/output interface 1110, which could be a serial bus compliant with Universal Serial Bus (USB) standards and having corresponding USB connectors. Alternatively, the image sequence may be retrieved from camera sensors 1100 and 1101 via Local Area Network 1190 or Wide Area Network 1195. The image sequence may also be downloaded from a local storage device (e.g., 1170), that can include SIM card, SD card, USB memory card, etc.

The sensors 1100 and 1101 are able to communicate directly with each other via sensor communication link 1102. One example of sensor 1100 communicating directly with sensor 1101 via sensor communication link 1102 is when sensor 1100 maintains its own database of spatial regions and corresponding brightness values; sensor 1100 can then communicate this information directly to sensor 1101, or vice versa.

The images are obtained by input/output interface 1110 and sent to the memory 1150 or another of the processing elements 1120 to 1168 via a system bus 1130. The processor 1120 is arranged to retrieve the sequence of images from sensors 1100 and 1101 or from memory 1150. The processor 1120 is also arranged to fetch, decode and execute all steps of the disclosed method. The processor 1120 then records the results from the respective operations to memory 1150, again using system bus 1130. Apart from memory 1150, the output could also be stored more permanently on a storage device 1170, via an input/output interface 1160. The same output may also be sent, via network interface 1164, either to a remote server which may be part of the network 1190 or 1195, or to personal computer 1180, using input/output interface 1110. The output may also be displayed for human viewing, using AV interface 1168, on a monitor 1185. Alternatively, the output may be processed further. One example of further processing may include using the output data, written back to memory 1150, memory 1170 or computer 1180, as the input to a background modelling system.

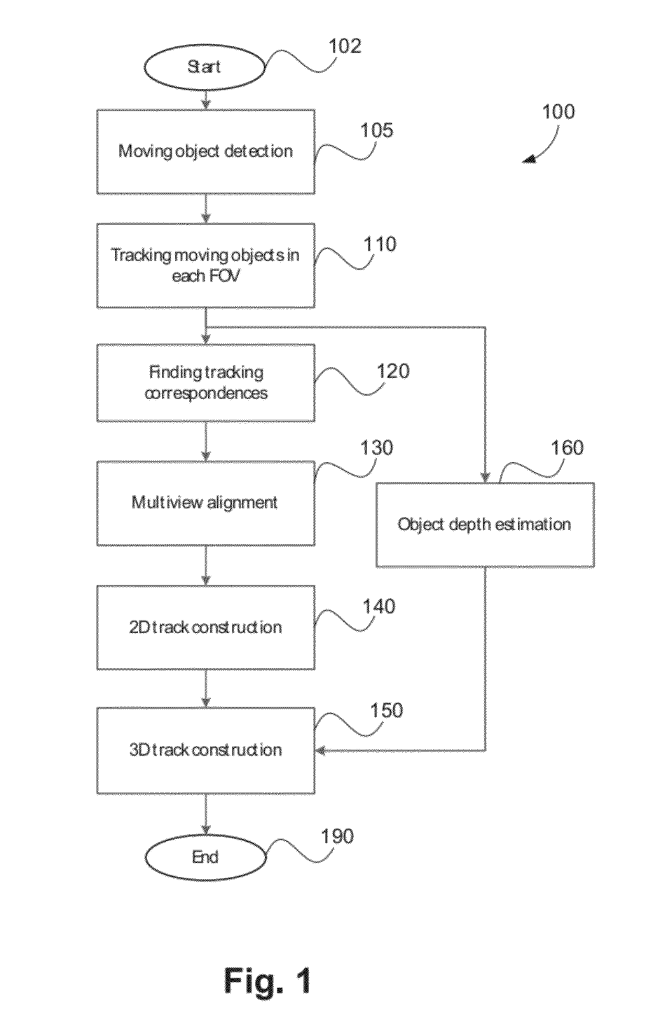

FIG. 1 is a flow diagram illustrating a method 100 for performing a multi-camera object tracking system. The multi-camera system begins at a Start step 102 and proceeds to step 105 to detect moving objects. The detection of moving objects may be performed on the processor 1120, for example, using technologies such as background modelling and foreground separation. Control then passes from step 105 to step 110, wherein the processor 1120 tracks moving objects in the field of view (FOV) of each camera in the multi-camera system. The tracking of moving objects may be performed, for example, using a technology such as Kalman filtering.

Control passes from step 110 to step 120, wherein the processor 1120 determines object track correspondences between object tracks from different FOVs. Determining the object tracking correspondences may be performed, for example, using technologies such as multi-camera object tracking or tracking interpolation. The corresponding set of tracks determined in step 120 is then used by the processor 1120 in step 130 to perform multi-view alignment, which determines the relative position of the ground plane in each FOV. The corresponding set of tracks determined in step 120 is also passed to an object depth estimation step 160, which estimates a depth of the object and sends the estimated depth for each detected object to a 3D track construction step 150. The output of the multi-view alignment module 130 is used in a two dimensional (2D) track construction step 140, wherein the processor 1120 generates an integrated picture of object trajectories on the ground plane. Control then passes from step 140 to the 3D construction step 150, wherein the processor 1120 utilises the 2D track generated in step 140 in conjunction with the output of the object depth estimation step 160 to transform the object trajectories on the ground plane to a 3D track representing the locational and dimensional information of the moving object in the world coordinate system. The method proceeds from step 160 to an End step 190 and the method 100 terminates.

As described above and indicated in FIG. 11, the above method may be embodied in various forms. In one embodiment, indicated by rectangle 1199, the method is implemented in an imaging device, such as a camera, a camera system having multiple cameras, a network camera, or a mobile phone with a camera. In this case, all the processing electronics 1110 to 1168 will be part of the imaging device, as indicated by rectangle 1199. As already mentioned in the above description, such an imaging device for capturing a sequence of images and tracking objects through the captured images will include: sensors 1100 and 1101, memory 1150, a processor 1120, an input/output interface 1110, and a system bus 1130. The sensors 1100 and 1101 are arranged for capturing the sequence of images in which objects will be tracked. The memory 1150 is used for storing the sequence of images, the objects detected within the images, the track data of the tracked objects and the signatures of the tracks. The processor 1120 is arranged for receiving, from the sensors 1100 and 1101 or from the memory 1150, the sequence of images, the objects detected within the images, the track data of the tracked objects and the signatures of the tracks. The processor 1120 also detects the objects within the images of the image sequences and associates the detected objects with tracks.

The input/output interface 1110 facilitates the transmitting of the image sequences from the sensors 1100 and 1101 to the memory 1150 and to the processor 1120. The input/output interface 1110 also facilitates the transmitting of pan-tilt-zoom commands from the PTZ controller 1103 to the sensors 1100 and 1101. The system bus 1130 transmits data between the input/output interface 1110 and the processor 1120.

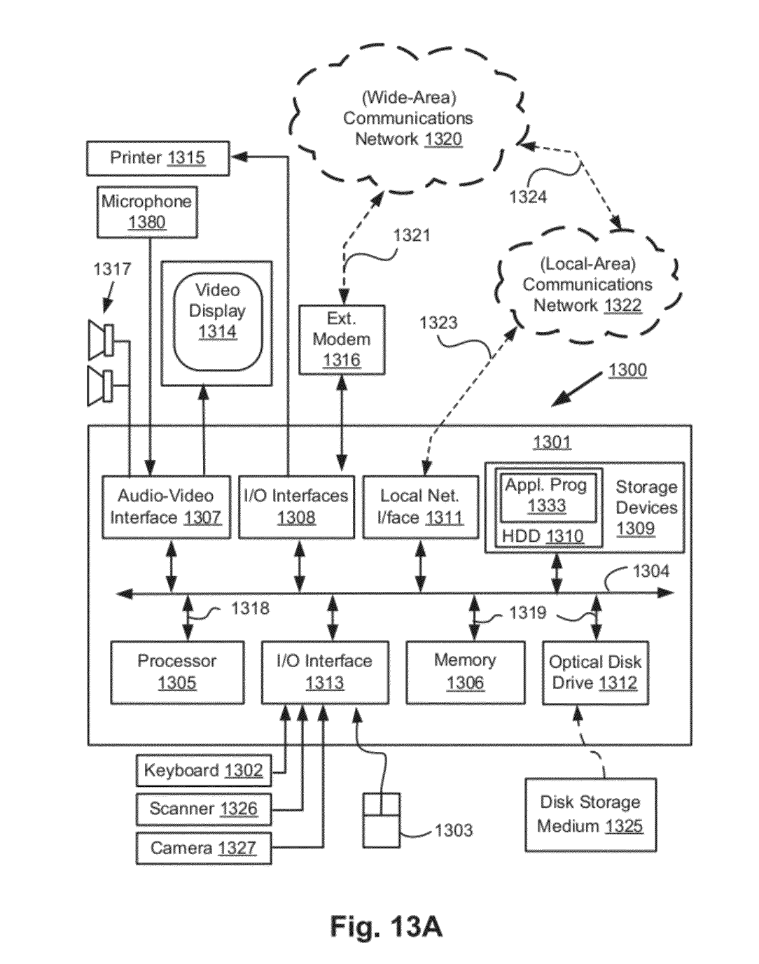

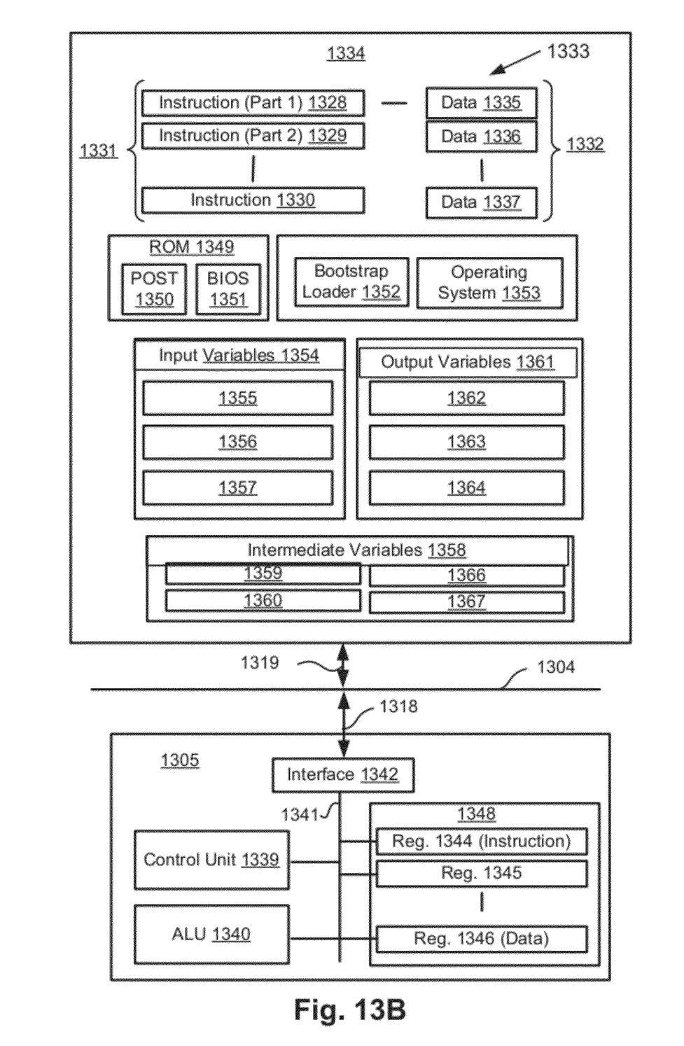

FIGS. 13A and 13B depict a general-purpose computer system 1300, upon which the various arrangements described can be practised.

As seen in FIG. 13A, the computer system 1300 includes: a computer module 1301; input devices such as a keyboard 1302, a mouse pointer device 1303, a scanner 1326, a camera 1327, and a microphone 1380; and output devices including a printer 1315, a display device 1314 and loudspeakers 1317. An external Modulator-Demodulator (Modem) transceiver device 1316 may be used by the computer module 1301 for communicating to and from a communications network 1320 via a connection 1321. The communications network 1320 may be a wide-area network (WAN), such as the Internet, a cellular telecommunications network, or a private WAN. Where the connection 1321 is a telephone line, the modem 1316 may be a traditional “dial-up” modem. Alternatively, where the connection 1321 is a high capacity (e.g., cable) connection, the modem 1316 may be a broadband modem. A wireless modem may also be used for wireless connection to the communications network 1320.

The computer module 1301 typically includes at least one processor unit 1305, and a memory unit 1306. For example, the memory unit 1306 may have semiconductor random access memory (RAM) and semiconductor read only memory (ROM). The computer module 1301 also includes an number of input/output (I/O) interfaces including: an audio-video interface 1307 that couples to the video display 1314, loudspeakers 1317 and microphone 1380; an I/O interface 1313 that couples to the keyboard 1302, mouse 1303, scanner 1326, camera 1327 and optionally a joystick or other human interface device (not illustrated); and an interface 1308 for the external modem 1316 and printer 1315. In some implementations, the modem 1316 may be incorporated within the computer module 1301, for example within the interface 1308. The computer module 1301 also has a local network interface 1311, which permits coupling of the computer system 1300 via a connection 1323 to a local-area communications network 1322, known as a Local Area Network (LAN). As illustrated in FIG. 13A, the local communications network 1322 may also couple to the wide network 1320 via a connection 1324, which would typically include a so-called “firewall” device or device of similar functionality. The local network interface 1311 may comprise an Ethernet™ circuit card, a Bluetooth™ wireless arrangement or an IEEE 802.11 wireless arrangement; however, numerous other types of interfaces may be practiced for the interface 1311.

The I/O interfaces 1308 and 1313 may afford either or both of serial and parallel connectivity, the former typically being implemented according to the Universal Serial Bus (USB) standards and having corresponding USB connectors (not illustrated). Storage devices 1309 are provided and typically include a hard disk drive (HDD) 1310. Other storage devices such as a floppy disk drive and a magnetic tape drive (not illustrated) may also be used. An optical disk drive 1312 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 1300.

The components 1305 to 1313 of the computer module 1301 typically communicate via an interconnected bus 1304 and in a manner that results in a conventional mode of operation of the computer system 1300 known to those in the relevant art. For example, the processor 1305 is coupled to the system bus 1304 using a connection 1318. Likewise, the memory 1306 and optical disk drive 1312 are coupled to the system bus 1304 by connections 1319. Examples of computers on which the described arrangements can be practised include IBM-PCs and compatibles, Sun Sparcstations, Apple Mac or alike computer systems.

The method of generating a common ground plane from a plurality of image sequences may be implemented using the computer system 1300 wherein the processes of FIGS. 1 to 12 and 14, described herein, may be implemented as one or more software application programs 1333 executable within the computer system 1300. The server 1275 of FIG. 12 may also be implemented using an instance of the computer system 1300. In particular, the steps of the method of detecting observations, determining a scene geometry, determining a spatial property of each camera, rectifying image sequences, determining statistical geometric properties, and determining relative scaling factors of a common ground plane are effected by instructions 1331 (see FIG. 13B) in the software 1333 that are carried out within the computer system 1300. The software instructions 1331 may be formed as one or more code modules, each for performing one or more particular tasks. The software may also be divided into two separate parts, in which a first part and the corresponding code modules performs the detecting observations, determining a scene geometry, determining a spatial property of each camera, rectifying image sequences, determining statistical geometric properties, and determining relative scaling factors of a common ground plane methods and a second part and the corresponding code modules manage a user interface between the first part and the user.

The software 1333 is typically stored in the HDD 1310 or the memory 1306. The software is loaded into the computer system 1300 from a computer readable medium, and executed by the computer system 1300. Thus, for example, the software 1333 may be stored on an optically readable disk storage medium (e.g., CD-ROM) 1325 that is read by the optical disk drive 1312. A computer readable medium having such software or computer program recorded on it is a computer program product. The use of the computer program product in the computer system 1300 preferably effects an apparatus for a multi-camera surveillance system and/or a video analysis system.

In some instances, the application programs 1333 may be supplied to the user encoded on one or more CD-ROMs 1325 and read via the corresponding drive 1312, or alternatively may be read by the user from the networks 1320 or 1322. Still further, the software can also be loaded into the computer system 1300 from other computer readable media. Computer readable storage media refers to any non-transitory tangible storage medium that provides recorded instructions and/or data to the computer system 1300 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 1301. Examples of transitory or non-tangible computer readable transmission media that may also participate in the provision of software, application programs, instructions and/or data to the computer module 1301 include radio or infra-red transmission channels as well as a network connection to another computer or networked device, and the Internet or Intranets including e-mail transmissions and information recorded on Websites and the like.

The second part of the application programs 1333 and the corresponding code modules mentioned above may be executed to implement one or more graphical user interfaces (GUIs) to be rendered or otherwise represented upon the display 1314. Through manipulation of typically the keyboard 1302 and the mouse 1303, a user of the computer system 1300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1317 and user voice commands input via the microphone 1380.

FIG. 13B is a detailed schematic block diagram of the processor 1305 and a “memory” 1334. The memory 1334 represents a logical aggregation of all the memory modules (including the HDD 1309 and semiconductor memory 1306) that can be accessed by the computer module 1301 in FIG. 13A.

When the computer module 1301 is initially powered up, a power-on self-test (POST) program 1350 executes. The POST program 1350 is typically stored in a ROM 1349 of the semiconductor memory 1306 of FIG. 13A. A hardware device such as the ROM 1349 storing software is sometimes referred to as firmware. The POST program 1350 examines hardware within the computer module 1301 to ensure proper functioning and typically checks the processor 1305, the memory 1334 (1309, 1306), and a basic input-output systems software (BIOS) module 1351, also typically stored in the ROM 1349, for correct operation. Once the POST program 1350 has run successfully, the BIOS 1351 activates the hard disk drive 1310 of FIG. 13A. Activation of the hard disk drive 1310 causes a bootstrap loader program 1352 that is resident on the hard disk drive 1310 to execute via the processor 1305. This loads an operating system 1353 into the RAM memory 1306, upon which the operating system 1353 commences operation. The operating system 1353 is a system level application, executable by the processor 1305, to fulfil various high level functions, including processor management, memory management, device management, storage management, software application interface, and generic user interface.

The operating system 1353 manages the memory 1334 (1309, 1306) to ensure that each process or application running on the computer module 1301 has sufficient memory in which to execute without colliding with memory allocated to another process. Furthermore, the different types of memory available in the system 1300 of FIG. 13A must be used properly so that each process can run effectively. Accordingly, the aggregated memory 1334 is not intended to illustrate how particular segments of memory are allocated (unless otherwise stated), but rather to provide a general view of the memory accessible by the computer system 1300 and how such is used.

As shown in FIG. 13B, the processor 1305 includes a number of functional modules including a control unit 1339, an arithmetic logic unit (ALU) 1340, and a local or internal memory 1348, sometimes called a cache memory. The cache memory 1348 typically includes a number of storage registers 1344-1346 in a register section. One or more internal busses 1341 functionally interconnect these functional modules. The processor 1305 typically also has one or more interfaces 1342 for communicating with external devices via the system bus 1304, using a connection 1318. The memory 1334 is coupled to the bus 1304 using a connection 1319.

The application program 1333 includes a sequence of instructions 1331 that may include conditional branch and loop instructions. The program 1333 may also include data 1332 which is used in execution of the program 1333. The instructions 1331 and the data 1332 are stored in memory locations 1328, 1329, 1330 and 1335, 1336, 1337, respectively. Depending upon the relative size of the instructions 1331 and the memory locations 1328-1330, a particular instruction may be stored in a single memory location as depicted by the instruction shown in the memory location 1330. Alternately, an instruction may be segmented into a number of parts each of which is stored in a separate memory location, as depicted by the instruction segments shown in the memory locations 1328 and 1329.

In general, the processor 1305 is given a set of instructions which are executed therein. The processor 1105 waits for a subsequent input, to which the processor 1305 reacts to by executing another set of instructions. Each input may be provided from one or more of a number of sources, including data generated by one or more of the input devices 1302, 1303, data received from an external source across one of the networks 1320, 1302, data retrieved from one of the storage devices 1306, 1309 or data retrieved from a storage medium 1325 inserted into the corresponding reader 1312, all depicted in FIG. 13A. The execution of a set of the instructions may in some cases result in output of data. Execution may also involve storing data or variables to the memory 1334.

The disclosed multi-camera video analysis arrangements use input variables 1354, which are stored in the memory 1334 in corresponding memory locations 1355, 1356, 1357. The video analysis arrangements produce output variables 1361, which are stored in the memory 1334 in corresponding memory locations 1362, 1363, 1364. Intermediate variables 1358 may be stored in memory locations 1359, 1360, 1366 and 1367.

Referring to the processor 1305 of FIG. 13B, the registers 1344, 1345, 1346, the arithmetic logic unit (ALU) 1340, and the control unit 1339 work together to perform sequences of micro-operations needed to perform “fetch, decode, and execute” cycles for every instruction in the instruction set making up the program 1333. Each fetch, decode, and execute cycle comprises:

(a) a fetch operation, which fetches or reads an instruction 1331 from a memory location 1328, 1329, 1330;

(b) a decode operation in which the control unit 1339 determines which instruction has been fetched; and

(c) an execute operation in which the control unit 1339 and/or the ALU 1340 execute the instruction.

Thereafter, a further fetch, decode, and execute cycle for the next instruction may be executed. Similarly, a store cycle may be performed by which the control unit 1339 stores or writes a value to a memory location 1332.

Each step or sub-process in the processes of FIGS. 1 to 12 and 14 is associated with one or more segments of the program 1333 and is performed by the register section 1344, 1345, 1347, the ALU 1340, and the control unit 1339 in the processor 1305 working together to perform the fetch, decode, and execute cycles for every instruction in the instruction set for the noted segments of the program 1333.

The method of generating a common ground plane from a plurality of image sequences may alternatively be implemented in dedicated hardware such as one or more integrated circuits performing the functions or sub functions of detecting observations, determining a scene geometry, determining a spatial property of each camera, rectifying image sequences, determining statistical geometric properties, and determining relative scaling factors of a common ground plane. Such dedicated hardware may include graphic processors, digital signal processors, or one or more microprocessors and associated memories.

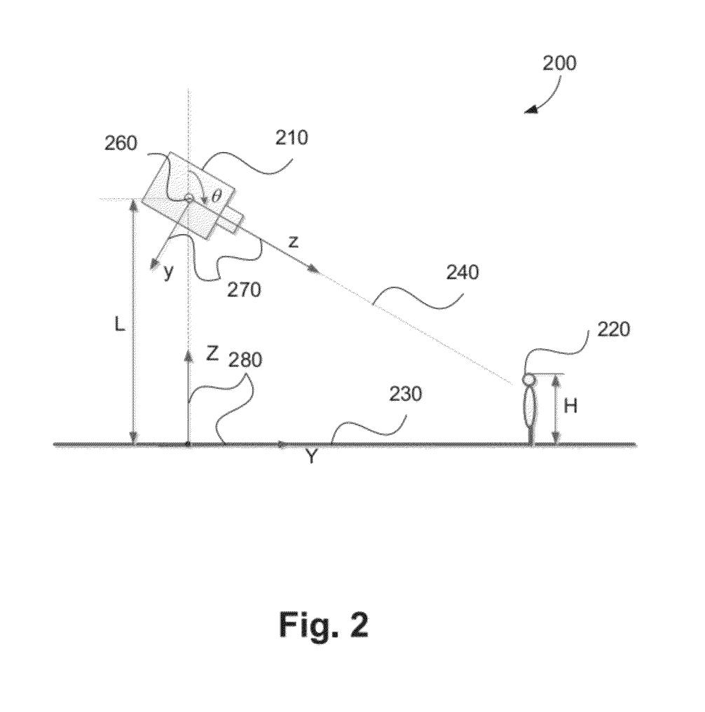

FIG. 2 is a schematic representation illustrating projective geometry of an exemplary object tracking scenario in a scene 200. The scene 200 includes three elements: a camera 210, a moving object 220, and a ground plane 230 on which the moving object stands. The camera 210 may be implemented using the PTZ camera 1000 of FIG. 10. The camera 210 has an optical centre 260, which is located at a height of L above the ground plane 230. An optical axis 240 of the camera 210 is tilted down to the ground plane at a tilt angle of θ. The object 220 moves on the ground plane 230 with an upright pose, and with a height of H in the true world.

Also shown in FIG. 2 are two coordinate systems: a camera coordinate system 270, and a world coordinate system 280. The camera coordinate system 270 is defined such that an origin of the camera coordinate system 270 is located at the optical centre 260 of the camera 210. A z-axis of the camera coordinate system is aligned to the optical axis 240 of the camera 210, and the x and y axes of the camera coordinate system are aligned to rows and columns of an image plane of the camera 210, respectively. Note that the x-axis is not depicted in FIG. 2. The world coordinate system 280 is defined as follows: the Z-axis of the world coordinate system is the norm of the ground plane 230. The Y-axis of the world coordinate system is aligned with the projection of the optical axis 240 on the ground plane 230. The X-axis (not shown in FIG. 2) of the world coordinate system is perpendicular to the Z and Y axes of the world coordinate system. The origin of the world coordinate system 280 is the projection of the optical centre 260 of the camera 210 on the ground plane 230. Please note the term image coordinate system is also used in this document instead of camera coordinate system. The image coordinate system is a coordinate system in the image plane. The x and y axes of the image coordinate system represent the rows and columns of the image plane of the camera 210, respectively. The origin of the image coordinate system is often located at the top-left corner of the image plane.

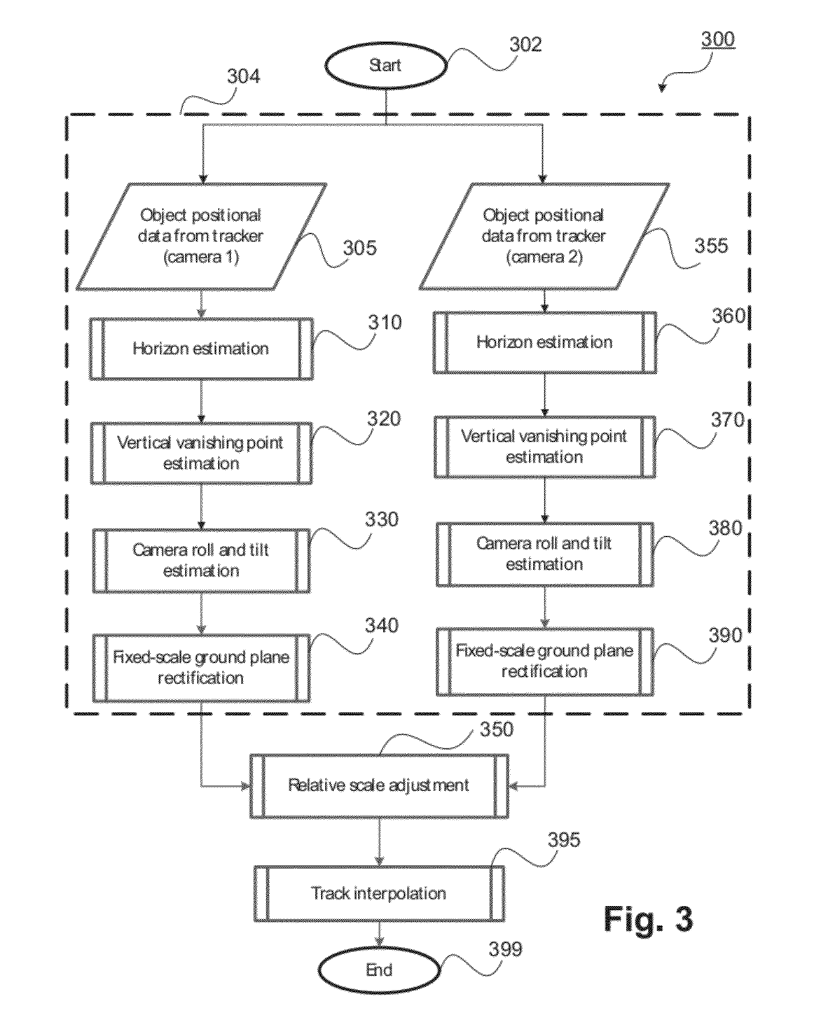

FIG. 3 is a system flow diagram of a method 300 of multi-view alignment. For the sake of clarity, the method depicted in FIG. 3 aligns two disjoint FOVs only. However, it will be appreciated by a person skilled in the art that this method is readily scalable for the multi-view alignment of three or more disjoint FOVs, such as may arise in a multi-camera surveillance system having two, three, or more cameras with disjoint fields of view, such as described above with reference to FIG. 12.

The proposed multi-view alignment imposes the following assumptions to the scene and the multi-camera object tracking system:
1) There exists a common ground plane between multiple disjoint FOVs.
2) Each camera 1000 in the system is located at a fixed height. The height of each camera may differ from the height of other cameras in the system. For example, a first camera is at a first height of 3 metres above the ground plane and a second camera is at a second height of 2 metres above the ground plane. Each camera is tracking object movements on the ground plane with a fixed tilt angle. Continuing the example, the first camera has a first tilt angle of 30 degrees and the second camera has a second tilt angle of 40 degrees.
3) The objects moving on the ground plane are in a consistent pose or appearance. In an example in which an object is a person, the method assumes that the person is in a consistent pose, such as an upright pose, with both head and feet positions visible in the images of each camera for the majority of the time. In another example in which the object is a car, the method assumes that the car is in a consistent appearance, with the car roof and the car tyre positions visible in the images of each camera for the majority of the time.
4) The object trajectories, including both the head and feet or car roof and car tyre positions, are known in each FOV before performing the multi-view alignment. This object positional information is obtained by running object detection and object tracking on an image sequence captured for each FOV.

The multi-view alignment method 300 depicted in FIG. 3 includes two sub-sequential processes:
1) Ground plane rectification for each field of view; and
2) Scale adjustment and multi-view alignment based on all disjoint FOVs.
   The ground plane rectification of the respective fields of view may be performed in any order and may be performed in parallel, in series, or a combination thereof. The method 300 begins at a Start step 302 and proceeds to a ground plane rectification process 304, which in this example runs in parallel based on the FOV of each camera. In the example of FIG. 3, there are two cameras in a multi-view alignment system, so the ground plane rectification process runs in parallel for each of the two cameras, camera 1 and camera 2.

For camera 1, control proceeds from the Start step 302 to step 305, in which camera 1 detects objects in an image sequence captured by camera 1. One of the methods for detecting the objects is through the object positional information in the FOV of camera 1 that is input to the multi-view alignment system 300. In a single moving object scenario, in one embodiment such object positional information is generated by performing foreground separation using a background modelling method such as Mixture of Gaussian (MoG) on processor 1005. The background model is maintained over time and stored in memory 1006. In another embodiment, a foreground separation method performed on Discrete Cosine Transform blocks generates object positional information. In a scenario involving multiple moving objects, one embodiment generates the positional information associated with each moving object by performing foreground separation followed with single camera tracking based on Kalman filtering on processor 1005. Another embodiment uses an Alpha-Beta filter for object tracking. In a further embodiment, the filter uses visual information about the object in addition to positional and velocity information.

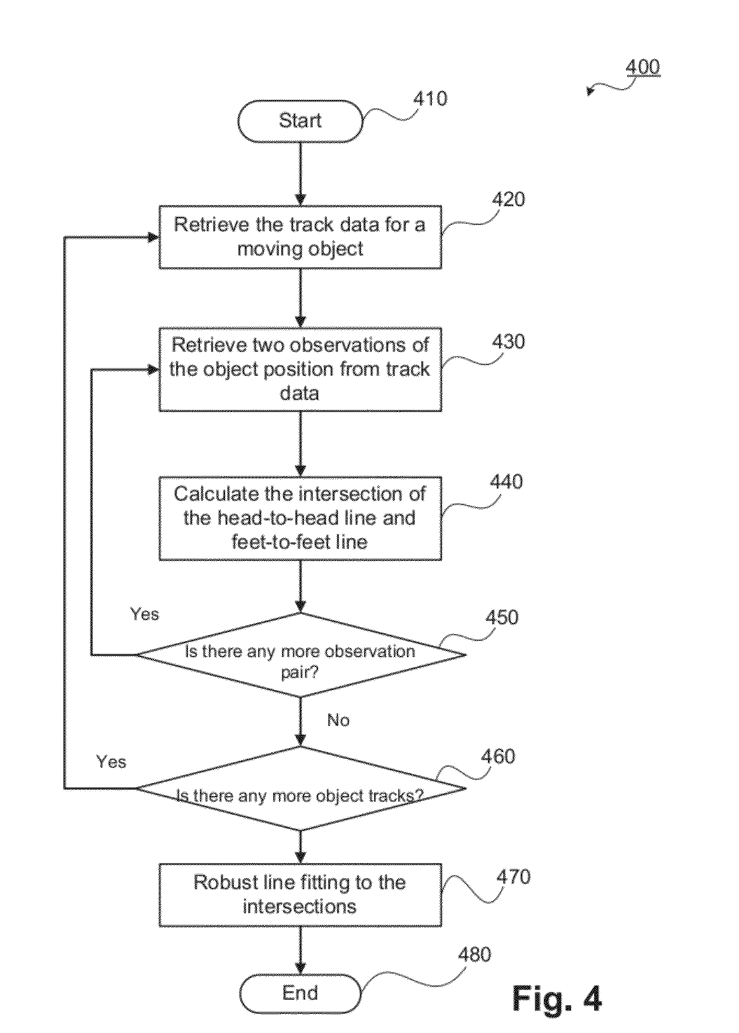

The object positional data determined in step 305 is used by the processor 1005 to determine the scene geometry of the scene captured by the camera. The object positional data from step 305 is first input to a horizon estimation step 310. The horizon estimation step 310 estimates the position of the horizon line in the image coordinate system, based on a set of predetermined features of the detected objects, such as the head and feet position of moving people in the scene, assuming the actual height of an object stays roughly the same over the image frames. Therefore, given two observations of the same object, the lines that connect the head and feet of the object over the observations, respectively, should be parallel to each other in the world coordinate system and the intersection of those lines is on the horizon. Details of the horizon estimation process of step 310 are described later with reference to FIG. 4.

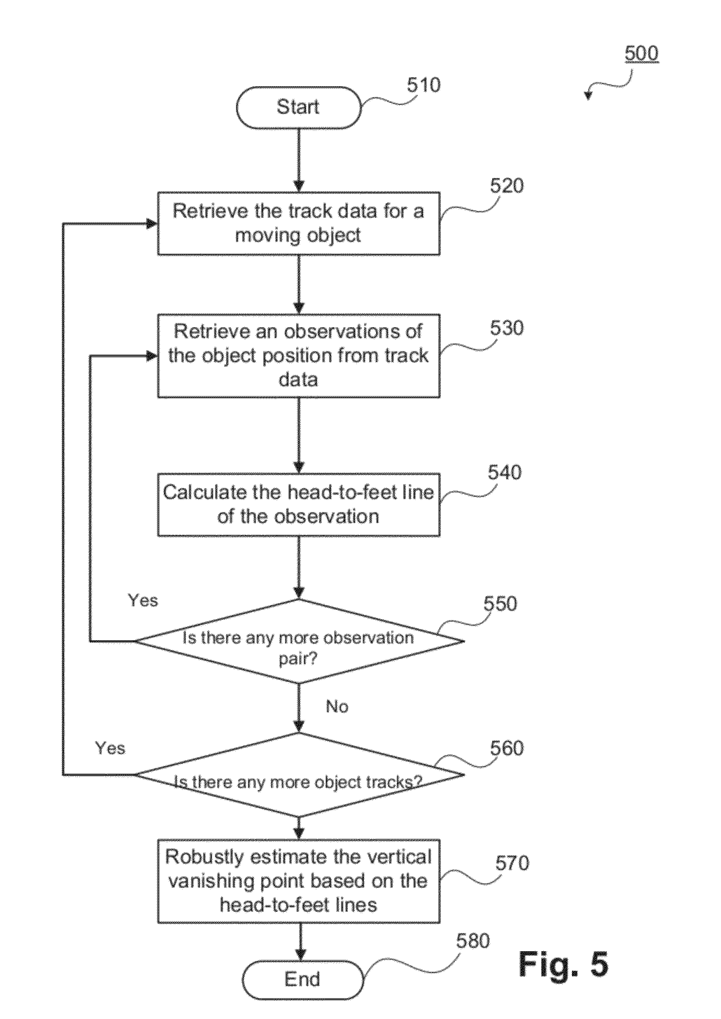

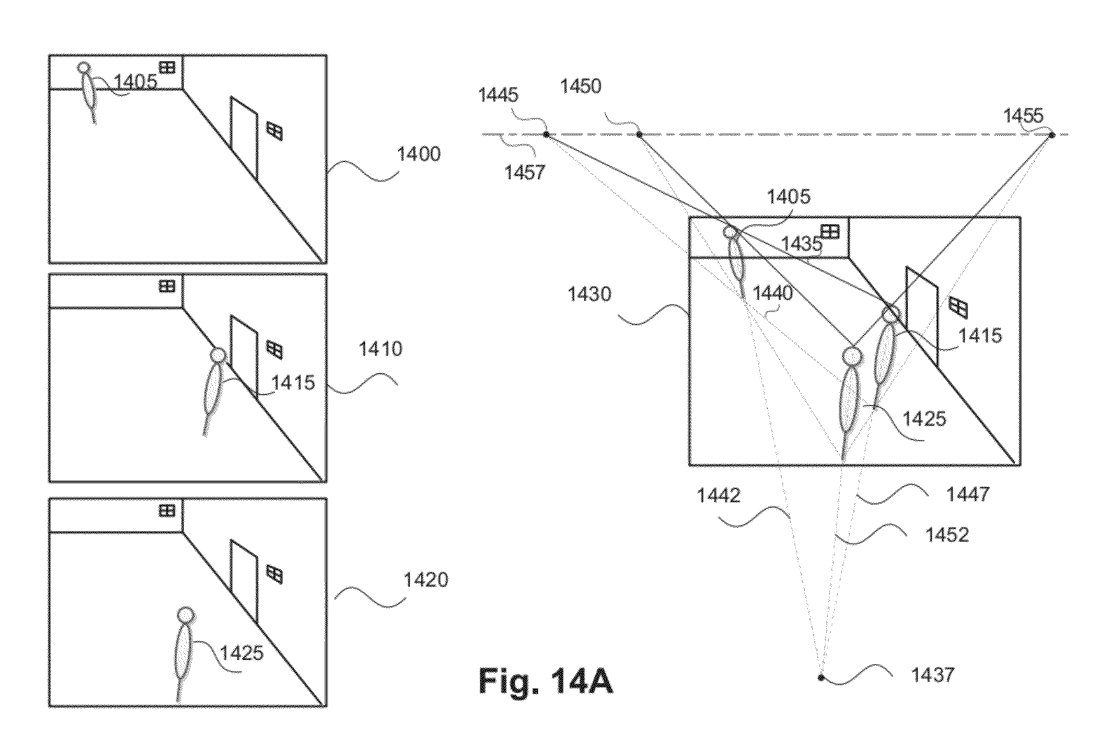

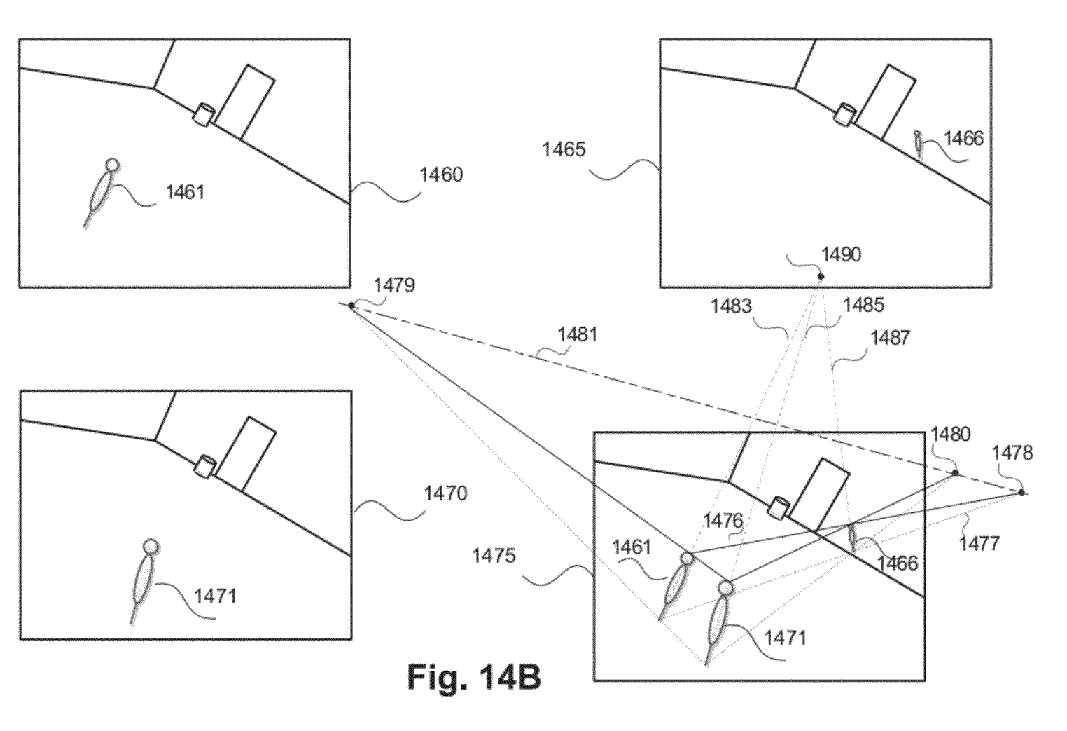

Control passes from step 310 to a next step 320, wherein the processor 1005 estimates a vertical vanishing point in the image coordinate system. Assuming an object moves through the camera view of a camera in an upright pose, the line joining the head and feet locations of each observation are parallel and the lines intersect at infinity in the vertical direction. This intersection is named the vertical vanishing point. It is possible to utilise other detected objects in the scene to establish the vertical vanishing point, including those objects that form part of the background of the scene. For example, it is possible to determine the vertical vanishing point using a table, a doorframe, a light-pole, or other detected object that has substantially vertical components. Details of the vertical vanishing point estimation process of step 320 are described later with reference to FIGS. 5 and 14.

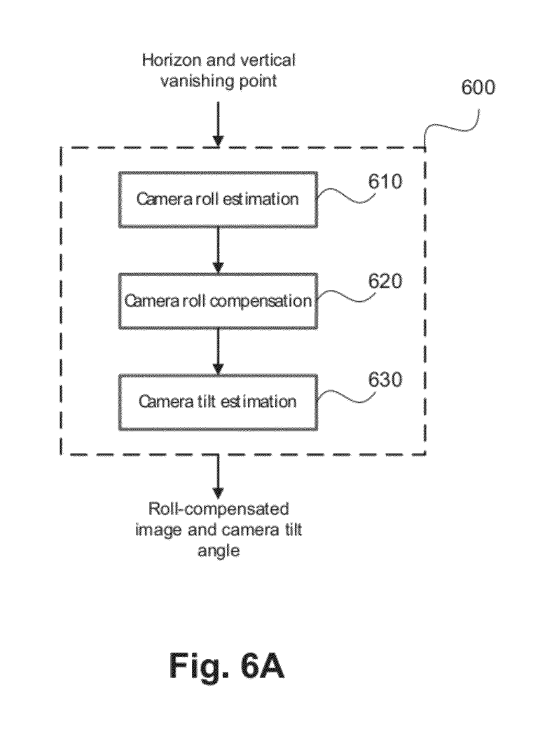

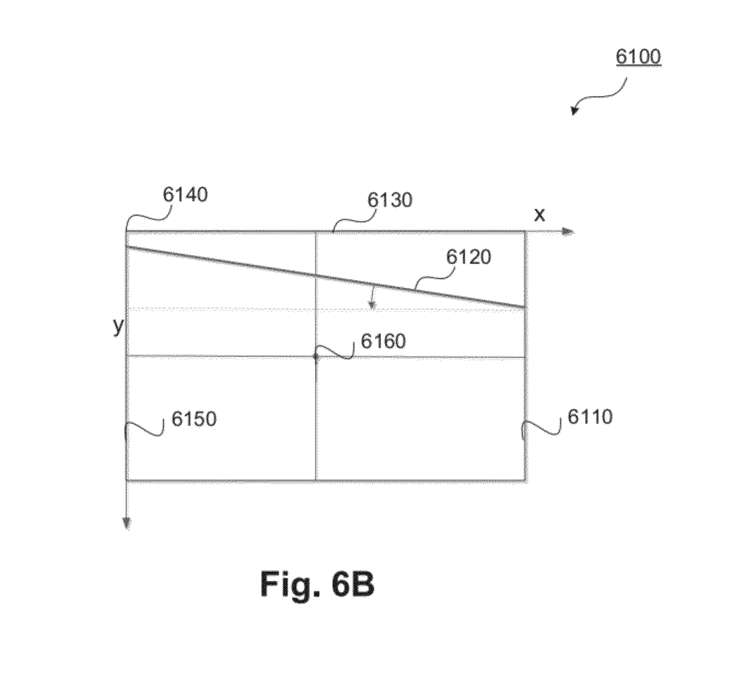

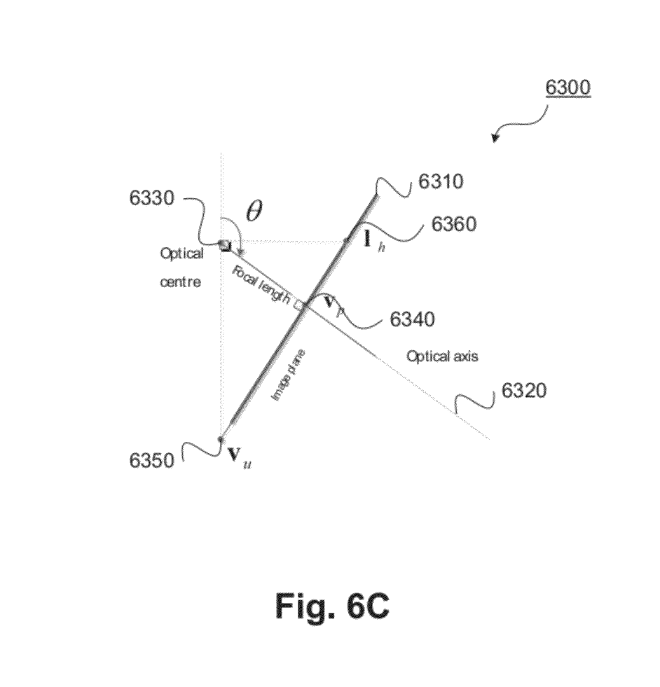

After the estimation of the scene geometry including the horizon line and the vertical vanishing point in the image using the set of predetermined features of the detected objects, control passes to step 330 to estimate the spatial property of the camera, including camera roll and tilt angle, based on the scene geometry estimated so far. Details of the camera roll and tilt estimation process of step 330 are described later on with reference to FIGS. 6A-C.

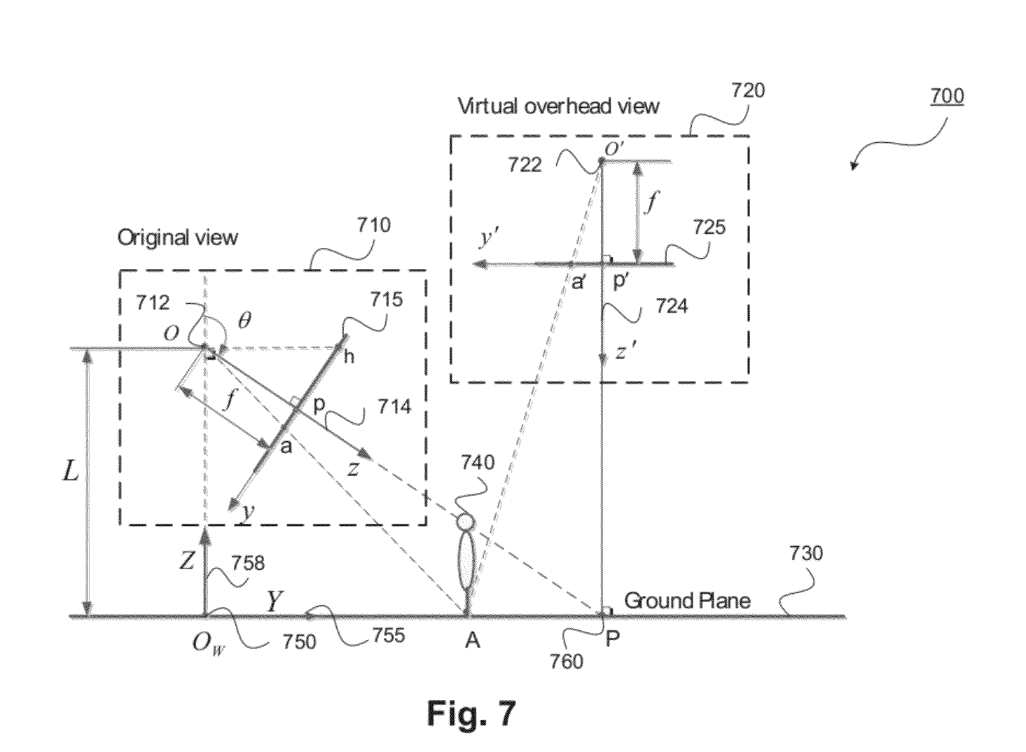

After determining the spatial property of the camera 1000, control passes from step 330 to step 340 to perform metric-rectification of the ground plane in the FOV of the camera 1. The ground plane of the current FOV is transformed to an overhead virtual position, based on the information about the horizon line, the vertical vanishing point, the camera roll and tilt angles, and the principal point of the camera 1000. The output of the fixed-scale ground plane rectification module 340 is a metric-rectified ground plane that contains the object trajectories of the current FOV, and with an unknown scaling factor representing the scale difference of the rectified ground plane to the true ground. Details of the fixed-scale ground plane rectification process of step 340 are described later with reference to FIG. 7.

The process of ground plane rectification for camera 2 runs in parallel to the process of ground plane rectification for camera 1 and the process is identical to the process on camera 1. From the Start step 302, the process of ground plane rectification for camera 2 begins at step 355, which determines the object positional data for camera 2. The object positional data determined in step 355 from the object detection and/or the object tracking is input to a horizon estimation step 360 and then to a vertical vanishing point estimation step 370 to estimate the position of the horizon line and the vertical vanishing point in the image coordinate system of the camera 2. Then, control passes from step 370 to a camera roll and tilt estimation step 380 to estimate the camera rolling and tilt angle of the camera 2, based on the positions of the horizon line and the vertical vanishing point in the image coordinate system. Finally, a fixed-scale ground plane rectification step 390 is activated to generate a metric-rectified ground plane that contains the object trajectories of the current FOV, and with an unknown scaling factor representing the scale difference of the rectified ground plane to the true ground.

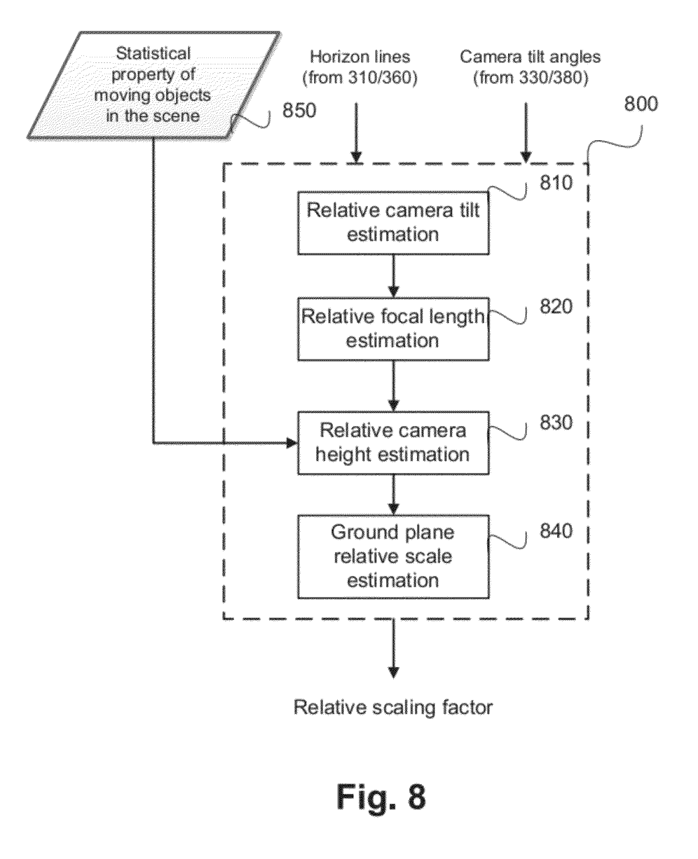

After running the ground plane rectification process on each camera in the multi-camera system under consideration, which in this example includes both camera 1 and camera 2, the two rectified ground planes output by the fixed-scaled ground plane rectification module 340 (for camera 1) and 390 (for camera 2), respectively, are input to a relative scale adjustment step 350. The relative scale adjustment step 350 calculates a relative scale difference between the two rectified ground planes, based on a statistical geometric property of moving objects in the scene. No information about internal/external parameters for either camera 1000, such as the focal length or the camera height above the ground, is required for the calculation. Details of the relative scale adjustment process of step 350 are described later with reference to FIG. 8.

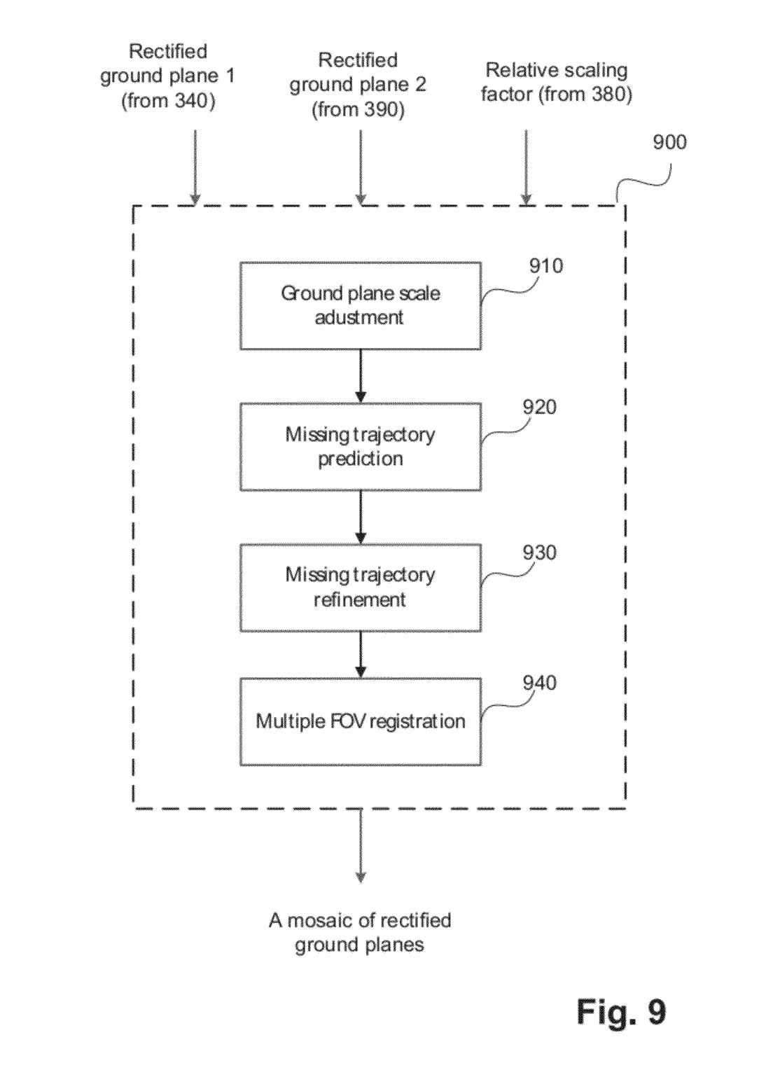

Following the relative scale adjustment module 350, control passes to a track interpolation step 395. The track interpolation step 395 receives as inputs the two rectified ground planes corresponding to the respective fields of view of camera 1 and camera 2. The track interpolation step 395 aligns the two rectified ground planes by establishing connections between the object trajectories on the two rectified ground planes. The output of the track interpolation module 395 includes: (1) the relative rotation and translation (in a common coordinate frame) between the two rectified ground planes; and (2) a mosaic of ground planes which are rectified and aligned to each other in a common coordinate frame. Details of the track interpolation process of step 395 are described later with reference to FIG. 9. Control passes from step 395 to an End step 399 and the process 300 terminates.

FIGS. 14A and 14B are schematic representations of a scenario showing a person walking in a corridor, captured by two cameras with disjoint FOVs. FIG. 14A shows the FOV of camera 1 1100 covering one corner of the corridor, taking three images (1400, 1410 and 1420). The first image 1400 captured by camera 1100 shows a person 1405 located at the top right of the image. The second image 1410 captured by camera 1100 shows a person 1415 approximately in the middle of the image. The third image 1420 captured by camera 1100 shows a person 1425 in the bottom centre of the image. FIG. 14B shows the FOV of camera 2 1101 covering another corner of the corridor, taking three images (1460, 1465 and 1470). The first image 1460 captured by camera 1101 shows a person 1461 located at the left centre of the image. The second image 1465 captured by camera 1101 shows a person 1466 approximately in the top right of the image. The third image 1470 captured by camera 1101 shows a person 1471 in the bottom centre of the image.

The following steps are applied to the two FOVs independently. For the FOV of camera 1 1100, the track data of the moving person (1405, 1415 and 1425) are obtained from step 420 of FIG. 4, to be described. Under the same image coordinate system, the three frames 1400, 1410, 1420 are superimposed together, giving a superimposed frame 1430 containing all three observations of the moving person 1405, 1410 and 1420.

For two observations 1405 and 1415 in the superimposed frame 1430, a first, head-to-head line 1435 is determined by connecting object head positions over the two observations 1405, 1415, and a second, feet-to-feet line 1440 is determined by connecting object feet positions over the two observations 1405, 1415. A point of intersection 1445 of the head-to-head line 1435 and feet-to-feet line 1440 is the horizontal vanishing point of the scene. Similarly, two more horizontal vanishing points 1450 and 1455 are determined from observation object pair 1405 and 1425 (giving horizontal vanishing point 1450), and observation object pair 1415 and 1425 (giving horizontal vanishing point 1455). Ideally, the three horizontal vanishing points should lie on the same line, which is the horizon vanishing line 1457. However, in practice, the three horizontal vanishing points 1445, 1450, 1455 may not lie exactly on the horizon vanishing line 1457, due to measurement error and noise. A robust line fitting step 470 may be used to fit the horizon vanishing line 1457 to the entire set of horizontal vanishing points. From images with observations 1460, 1465 and 1470 taken by camera 2 1101, a horizontal vanishing line 1481 for camera 2 1101 can be estimated in the same way. That is to say, a head-to-head line and a feet-to-feet line of observations 1461 and 1471 gives a horizontal vanishing point 1479, observation pair 1466 and 1471 gives the horizontal vanishing point 1480, and observation pair 1461 and 1466 gives the horizontal vanishing point 1478. These three horizontal vanishing points 1479, 1480, 1478 are used to estimate the horizon vanishing line 1481 for camera 2 1101 with a different FOV of camera 1 1100.

For two observations 1405 and 1415 in the superimposed frame 1430, a first, head-to-feet line 1442 is determined by connecting object head position and feet position from the first observation 1405. Similarly, two more head-to-feet lines 1447 and 1452 are determined by connecting object head position and feet position from the second observation 1415 (giving line 1447) and from the third observation 1425 (giving line 1452). Ideally, the three head-to-feet lines should intersect at one point, called vertical vanishing point 1437. However, in practice, the three head-to-feet lines do not intersect at one point due to measurement error and noise. An optimal vertical vanishing point is estimated in step 570.

From images with observations 1460, 1465 and 1470 taken by camera 2 1101, a vertical vanishing point 1490 for camera 2 1101 can be estimated in the same way. That is to say, observation 1461 gives a head-to-feet line 1483, observation 1466 gives a head-to-feet line 1487, and observation 1471 gives a head-to-feet line 1485. These three head-to-feet lines 1483, 1487, 1485 are used to estimate the vertical vanishing point 1490 for camera 2 1101 with a different FOV of camera 1 1100. The roll angles of the two cameras are obtained from step 600 of FIG. 6A, to be described, and the orientations of the image planes are adjusted from step 610 of FIG. 6A, so that the horizontal vanishing lines (1457 and 1481) are horizontal, as will be described in method 600 of FIG. 6A. Ground planes for the FOVs of camera 1 1100 and camera 2 1101 are rectified as described in FIG. 7. Using the statistical geometric properties of the observations to generate the relative scaling factors of the two cameras, a mosaic of rectified ground planes is generated by the processor 1005, as described in method 900 of FIG. 9.

The horizon estimation process performed by the horizon estimation steps 310 and 360 in FIG. 3 is now described in detail with reference to FIG. 4.

FIG. 4 is a flow diagram illustrating a horizon estimation process 400 based on moving objects on the ground plane. The horizon estimation process 400 begins at a Start step 410 and proceeds to step 420. In step 420, the processor 1005 retrieves the track data for a moving object in the current FOV. These track data are produced by an object detector and a single-camera tracker running in the image coordinate system of the current FOV. The track data comprise a set of object positional data. Each positional data item represents an observation of the location of the moving object (such as the head, the feet, and the centroid) in the image coordinate system.

Control passes from step 420 to step 430, in which the processor 1005 retrieves two observations of the object position from the track data stored in memory 1006 and through processor 1005 computes one line that connects the object head position over the two observations, and another line that connects the object feet position over the two observations. In the example shown in FIGS. 14A and 14B, for two observations 1405 and 1415 in the superimposed frame 1430, a line 1435 is determined by connecting object head positions over the two observations, and another line 1440 is determined by connecting object feet positions over the two observations. Assuming the height of an object stays substantially the same over the two observations, these two lines 1435 and 1440 are parallel to each other in the world coordinate system and the intersection of these two lines 1435, 1440 is on the horizon. The object head and the feet positions in the two observations may be represented in homogenous coordinate system, respectively, as:

{hᵢ=(xᵢ^{t},yᵢ^{t},1)^{T}|i=1,2} (1)
where x₁^{t} and y₁^{t} are the x- and y-coordinate of the head position hᵢ and

{fᵢ=(xᵢ^{b},yᵢ^{b},1)^{T}|i=1,2}. (2)
where x₁^{b} and yᵢ^{b} are the x- and y-coordinate of the head position fᵢ
   Then, the head-to-head line lₜ that connects the object head positions over the two observations is given by the cross product of the two head positions h₁ and h₂:

lₜ=h₁×h₂, (3)

and the feet-to-feet line l_{b} that connects the object feet positions over the two observations is given by the cross product of the two feet positions f₁ and f₂:

l_{b}=f₁×f₂. (4)

In a next step 440, the process computes the intersection of the head-to-head line and the feet-to-feet line l_{b} on processor 1005. In the exemplary embodiment, the intersection pⱼ of these two lines is computed in the homogeneous space as the cross product of the two lines lₜ and l_{b}, as shown in (5):

pⱼ=lₜ×l_{b}. (5)

This intersection represents a horizontal vanishing point that lies on the horizon line to be estimated.

Step 440 for determining the intersection of the head-to-head line and the feet-to-feet line uses two features of the detected objects. First, step 440 links together a set of first features, which is the heads of the detected people in the scene, as the head-to-head line. Then, step 440 links together a set of second features, which is the feet of the detected people in the scene, as the feet-to-feet line. The horizontal vanishing point of the scene is then the intersection of the head-to-head line and the feet-to-feet line.

Control passes to decision step 450, in which the process checks whether all the pairs of observations have been processed for the current track. If there are any more observation pairs remaining, Yes, the process returns to step 430 to retrieve a new pair of observations. However, if at step 430 there are no more observation pairs remaining, No, the process moves on to a next decision step 460.

In the step 460, the process checks whether all the track data has been processed for the current track. If there are any more object tracks remaining to be processed, Yes, the process returns to step 420, which retrieves a new track associated with a different moving object. However, if at step 460 there are no more object tracks remaining to be processed, No, the process moves on to a next step 470.

After processing all the pairs of observations from all the tracks, the process moves on to step 470, which estimates the horizon vanishing line in the image coordinates system by linking and fitting a line to the entire set of horizontal vanishing points {pᵢ=(xᵢ^{p},yᵢ^{p},1)^{T}} obtained so far as stored in memory 1006.

Let the horizon line in the image coordinate system be:

lₕ=(aₕ,bₕ,cₕ)^{T}, (6)

the line fitting process for an estimate of the horizon line \hat{l}ₕ is given by the line that produces the minimum distance between the estimated horizon line and the set of horizontal vanishing points, which is

$${\hat{I}}_{h} = arg {min}_{l} {\sum }_{i}^{ } {( {x}_{i}^{p} , {y}_{i}^{p} , 1 )}^{T} \frac{{\hat{I}}_{h}}{‖ {\hat{I}}_{h} ‖} ) . \qquad ( 7 )$$

In one embodiment, this line fitting is implemented using the robust data fitting algorithm RANSAC, which is known to those skilled in the relevant art. The RANSAC algorithm is able to reject possible outliers in the estimated horizontal vanishing point set, and fitting a line using only those inliers which pass a confidence test. In another embodiment, the Maximum Likelihood Estimation (MLE) is used. In yet another embodiment, the Nonlinear Mean Square Estimation (NMSE) algorithm is used.

The horizon vanishing line estimation process 400 proceeds from step 470 to an End step 480 and terminates.

The vertical vanishing point estimation process run by the vertical vanishing point estimation steps 320 and 370 of FIG. 3 is now described in detail with reference to FIG. 5.

FIG. 5 is a flow diagram illustrating a vertical vanishing point estimation process 500 based on moving objects on the ground plane. The vertical vanishing point estimation process 500 starts from a Start step 510 and proceeds to step 520. In step 520, the process retrieves the track data for a moving object in the current FOV. The function of step 520 is identical to step 420 in FIG. 4.

In a next step 530, the process retrieves an observation of the object position from the track data. This observation represents the location of the moving object (such as, for example, the head, the feet, and the centroid) in the current image or video frame.

In a next step 540, processor 1005 computes the lines that connect the head position to the head position of the observations. Let hᵢ and fᵢ be the head and the feet positions, respectively, of the moving object in the observation, then the line that connects the object head and feet positions in the observation is given by lᵢ=hᵢ×fᵢ.

In a decision step 550, the process checks whether all the observations have been processed for the current track. If there are any more observation pairs remaining to be processed, Yes, the process returns to step 530 to retrieve an observation from memory 1006. However, if at step 550 there are no more observation pairs remaining to be processed, No, the process moves on to the next step 560.

In decision step 560, the process checks whether all the track data has been processed for the current track. If there are any object tracks remaining to be processed, Yes, the process returns to step 520 to retrieve from memory 1006 a new track associated to a different moving object. However, if at step 560 there are no object tracks remaining to be processed, No, the process moves on to the next step 570.

After processing all the observations from all the tracks in memory 1006, the process moves on to step 570, which estimates a position for the vertical vanishing point in the image coordinates system. Assuming the object moves on the ground plane in an upright pose, the line joining the head and feet locations of each observation are parallel and intersect at infinity in the vertical direction, namely the vertical vanishing point. In the preferred embodiment, the optimal vertical vanishing point vᵤ=(xᵤ,yᵤ,1)^{T}, is estimated as follows:

$${v}_{u} = arg {min}_{u} {\sum }_{i}^{ } ( \frac{{( {m}_{i} \times u )}^{T} \cdot {h}_{i} + {( {m}_{i} \times u )}^{T} \cdot {f}_{i}}{{‖ {m}_{i} \times u ‖}_{2}} ) , \qquad ( 8 )$$

where mᵢ denotes the line linking the midpoint, u is a candidate vertical vanishing point and ∥•∥₂ represents an L₂ norm. The term mᵢ×u gives an estimate of the line linking the head and feet positions of the observation \hat{l}ᵢ. In other words, the candidate vanishing point u is given by u=×\hat{l}₁×\hat{l}₂ and, i.e., where \hat{l}ᵢ, wherein i is 1, 2 etc., indicating the estimated head-to-feet lines for different observations produced by step 540.

Control passes from step 570 to an End step 580 and the vertical vanishing point estimation process 500 terminates.

The camera roll and tilt estimation process run by the camera roll and tilt estimation steps 330 and 380 in FIG. 3 is now described in detail with reference to FIGS. 6A-C.

FIG. 6A is a flow diagram showing the camera roll and tilt estimation process 600. The input to the camera roll and tilt estimation process 600 includes the horizon line output by the horizon estimation steps 310, 360 of FIG. 3 and the vertical vanishing point output by the vertical vanishing point estimation steps 320, 370 of FIG. 3. The output of the camera tilt and estimation process 600 includes a roll-compensated image and the tilt angle of the camera 1000.

The cameras roll and tilt estimation process 600 starts with a camera roll estimation step 610. The camera roll estimation step 610 estimates the roll angle of the camera 1000, based on the position of the horizon line in the image plane. FIG. 6B illustrates an example 6100 consisting of an image plane 6110 and a horizon line 6120. The image plane 6110 and horizon line 6120 are located in an image coordinate system consisting of origin 6140, x-axis 6130, and y-axis 6150. The origin 6140 of the image coordinate system is located at the top-left corner of the image plane 6110. The x-axis 6130 of the image coordinate system is aligned with the rows of the image plane 6110. The y-axis 6150 of the image coordinate system is aligned with the columns of the image plane 6110. The centre 6160 of the image plane is the principal point. Due to the camera roll, the horizon line 6120 is non-parallel to the x-axis of the image coordinate system. The angle between the horizon line 6120 and the x-axis 6130 represents the camera roll angle. Denoting the horizon line as lₕ=(aₕ,bₕ,cₕ)^{T} in the image coordinate system, then the camera roll angle ρ is given by

$$ρ = {tan}^{- 1} ( \frac{{b}_{h}}{{a}_{h}} ) \qquad ( 9 )$$

Returning to FIG. 6A, following the camera roll estimation step 610 is a camera roll compensation step 620. The camera roll compensation step 620 adjusts the position of the image plane 6110 to make the horizon line 6120 horizontal. Referring to FIG. 6B, in one embodiment this is implemented by a rotation (−ρ) of the image plane 6110 around the principal point 6160, where the rotation matrix is given by

$$R ( - ρ ) = [ \begin{matrix}cos ρ & sin ρ \\ - sin ρ & cos ρ\end{matrix} ] \qquad ( 10 )$$

Returning again to FIG. 6A, the last step of the cameras roll and tilt estimation process 600 is a camera tilt estimation step 630. The camera tilt estimation step 630 estimates the tilt angle of the camera based on the relative position of the optical axis, the optical centre, and the image plane of the camera. FIG. 6C shows a side view of a pinhole camera model 6300 that includes an optical centre 6330, an optical axis 6320, and an image plane 6310. The optical centre 6330 is a theoretical point in the pinhole camera model 6300 through which all light rays travel when entering the camera 1000. The optical axis 6320 is an imaginary line that defines the path passing through the optical centre 6300 and perpendicular to the image plane 6340. The image plane is a plane located in front of the optical centre 6330 and perpendicular to the optical axis 6320. The distance from the optical centre 6330 to the image plane 6310 along the optical axis 6320 is called the focal length. Let vᵤ=(xᵤ,yᵤ,1)^{T} be the vertical vanishing point 6350, let lₕ=(aₕ,bₕ,cₕ)^{T} be the horizon line 6360, and let vₚ=(xₚ,yₚ,1)^{T} be the principal point 6340. Without loss of generality, a zero camera roll angle is assumed. Hence, the horizon line 6360 becomes a dot on the image plane. The camera tilt angle, θ, is the angle between the optical axis 6320 and a line connecting the optical centre 6330 and the vertical vanishing point 6350, i.e.,

$$θ = {tan}^{- 1} \sqrt{\frac{{‖ {v}_{u} - {v}_{p} ‖}_{2}}{{‖ {v}_{p}^{T} {I}_{h} ‖}_{2}}} , \qquad ( 11 )$$

where ∥•∥₂ represents an L₂ norm.

Now the fixed-scale ground plane rectification process performed by the fixed-scale ground plane rectification steps 340 and 390 in FIG. 3 is described in detail with reference to FIG. 7. FIG. 7 illustrates a side view of the geometric relationship 700 between an unrectified camera coordinate system (namely the original view) 710, a rectified camera coordinate system (namely the virtual overhead view) 720, and a world coordinate system 750. The unrectified camera coordinate system 710 includes an optical centre 712, an optical axis 714, and an image plane 715. The origin of the unrectified camera coordinate system is located at the top-left corner of the image plane 715, with the x-axis (not shown) and the y-axis of the unrectified camera coordinate system being the columns and the rows of the image plane 715, respectively; and z-axis of the unrectified camera coordinate system being the optical axis 714. Without loss of generality, a zero camera roll angle is assumed for the original view 710. Hence, the horizon line of original view 710 becomes a point h on the image plane 715. In a similar fashion, the rectified camera coordinated system 720 includes an optical centre 722, an optical axis 724, and an image plane 725. The origin of the camera coordinate system 720 is located at the top-left corner of the image plane 725, with the x′-axis (not shown) and the y′-axis of the rectified camera coordinate system being the columns and the rows of the image plane 725, respectively; and z′-axis of the rectified camera coordinate system being the optical axis 724.

The geometric relationship between the original view 710 and the virtual overhead view 720 is described in the world coordinate system 750 with respect to a ground plane 730 on which the moving object 740 stands. The world coordinate system is defined as follows: the origin of the world coordinate system 750 is the projection of the optical centre 712 of the original view 710 onto the ground plane 730. The Y-axis 755 of the world coordinate system 750 is the projection of the optical axis 714 on the ground plane 730. The Z-axis 758 of the world coordinate system 750 is the norm of the ground plane 730 (pointing upward).

Given the world coordinate system 750, and denoting the intersection of the optical axis 714 with the ground plane as point P (760), then, in one embodiment, the geometric relationship between the original view 710 and the virtual overhead view 720 is modelled by a rotation in the world coordinates system 750 around the X-axis of the world coordinate system. In particular, the virtual overhead view 720 is generated from the original view 710 by rotating the unrectified camera coordinate system around the point P to a position where the new optical axis (724) becomes perpendicular to the ground plane 730.

Given the geometric relationship between the original view 710 and the virtual overhead view 720, the homography between the image planes of two views is now derived. Let X_{A}=(X_{A},Y_{A},Z_{A},1)^{T} represent a 3D point A in the world coordinate system, and let xₐ=(xₐ,yₐ,1)^{T} be the back-projection of this point in image plane 715, then

x=PX, (12)

where P is a 3×4 projection matrix presenting the camera geometry of the scene. Since point A is on the ground plane, the projection matrix represented by P is reduced to be an 3×3 matrix \tilde{P} which represents the homography between the image plane 715 and the ground plane 730, i.e.,

xₐ=PX_{A}≡P(x_{A},Y_{A},Z_{A},1)^{T}=\tilde{P}(X_{A},Y_{A},1)^{T} (13)

By taking into account that Z_{A}=0, expressing Eqn (13) using the image coordinate system 715 and the world coordinate system 730, results in

$$( \begin{matrix}{x}_{a} - {x}_{p} \\ {y}_{a} - {y}_{p} \\ 1\end{matrix} ) ≅ P ( \begin{matrix}{X}_{A} \\ {Y}_{A} \\ 1\end{matrix} ) , \qquad ( 14 )$$

where (xₚ,yₚ,1)^{T} is the principal point p of the image plane 715. The image-to-ground plane homography of the original view, \tilde{P}₁, is given by

$${\tilde{P}}_{1} = [ \begin{matrix}\frac{f}{α} & 0 & 0 \\ 0 & \frac{f}{α} cos θ & \frac{f}{α} L sin θ \\ 0 & sin θ & - L cos θ\end{matrix} ] \qquad ( 15 )$$

where f is the physical focal length of the camera 1000, α is the pixel aspect ratio of the image sensor (i.e., metres/pixel); L is the height of the optical centre 712 above the ground plane 730, and θ is the camera tilt angle output by the camera roll and tilt estimation module 340, 390 of FIG. 3.

The image-to-ground plane homography for the virtual overhead view 720 is derived in a similar manner. Let (x_{a′},y_{a′}, 1)^{T} be the back-projection of the world point A on the image plane 725, and let (x_{p′},y_{p′},1)^{T} be the principal point p′ of the image plane 725, then

$$( \begin{matrix}{x}_{{a}^{′}} - {x}_{{p}^{′}} \\ {y}_{{a}^{′}} - {y}_{{p}^{′}} \\ 1\end{matrix} ) ≅ {P}_{2} ( \begin{matrix}{X}_{A} \\ {Y}_{A} \\ {Z}_{A} \\ 1\end{matrix} ) = {\tilde{P}}_{2} ( \begin{matrix}{X}_{A} \\ {Y}_{A} \\ 1\end{matrix} ) , \qquad ( 16 )$$

where the image-to-ground plane homography for the virtual overhead view 720 view is given by

$${\tilde{P}}_{2} = [ \begin{matrix}\frac{f}{α} & 0 & 0 \\ 0 & - \frac{f}{α} & - \frac{f}{α} L tan θ \\ 0 & 0 & - \frac{L}{cos θ}\end{matrix} ] \qquad ( 17 )$$

wherein θ is the camera tilt angle output by the camera roll and tilt estimation module 340, 390 of FIG. 3.
Based on (16) and (17), the homography that maps the image plane 715 of the original view 710 to the image plane 725 of the virtual overhead view 720 is given by

$$H = {\tilde{P}}_{2} {\tilde{P}}_{1}^{- 1} ≅ [ \begin{matrix}1 & 0 & 0 \\ 0 & - \frac{1}{cos θ} & 0 \\ 0 & - \frac{α}{f} tan θ & 1\end{matrix} ] \qquad ( 18 )$$

Converting this homography H back to Cartesian coordinates, results in

$${x}_{{a}^{′}} - {x}_{{p}^{′}} = \frac{- ( {x}_{a} - {x}_{p} ) cos θ}{{α}_{f} ( {y}_{a} - {y}_{p} ) sin θ - cos θ} \\ {y}_{{a}^{′}} - {y}_{{p}^{′}} = \frac{{y}_{a} - {y}_{p}}{{α}_{f} ( {y}_{a} - {y}_{p} ) sin θ - cos θ} , \qquad ( 19 )$$

where (xₐ,yₐ,1)^{T} is the back-projection of the world point A on the image plane 715, (xₚ,yₚ,1)^{T} is the principal point p of the image plane 715, (x_{a′},y_{a′},1)^{T} is the back-projection of the world point A on the image plane 725, (x_{p′},y_{p′},1)^{T} is the principal point p′ of the image plane 725, and α_{f}=α/f. This gives a direct mapping between the image plane 715 of the original view 710 and the rectified image plane 725 of the virtual overhead view 720. Now referring back to FIG. 6C, based on the triangulation between the optical centre 6330, the principal point 6340, the horizon line 6360, and the vertical vanishing point 6350, and the camera tilt angle θ, the parameter α_{f} is derived as follows

$${α}_{f} = \frac{cot θ}{{y}_{h} - {y}_{p}} \qquad ( 20 )$$

Inserting Eqn (20) back into Eqn (19) leads to a pixel-wise metric rectification that does not depend on any camera internal parameter (such as focal length, pixel aspect ratio, etc.):

$${x}_{{a}^{′}} - {x}_{{p}^{′}} = \frac{{x}_{a} - {x}_{p}}{1 + ( {y}_{a} - {y}_{p} ) / ( {y}_{p} - {y}_{h} )} \\ {y}_{{a}^{′}} - {y}_{{p}^{′}} = - \frac{1}{cos θ} \cdot \frac{{y}_{a} - {y}_{p}}{1 + ( {y}_{a} - {y}_{p} ) / ( {y}_{p} - {y}_{h} )} \qquad ( 21 )$$

Please note that the image generated by the pixel-wise metric rectification (21) has an unknown scaling factor to the true measure. The value of this scaling factor depends on the camera focal length f, the camera height L, and the camera tilt angle θ as follows

$$S = - \frac{f}{L} \cdot cos θ \qquad ( 22 )$$

This scaling factor is fixed per FOV. For any two rectified ground planes, the relative scale difference between the two is resolved in the relative scale adjustment module 350 of FIG. 3 using a statistical geometric property about the moving objects in the scene. This concludes the description of the fixed-scale ground plane rectification process performed by the fixed-scale ground plane rectification steps 340 and 390 in FIG. 3.

Now the relative scale adjustment process performed by the relative scale adjustment module 350 of FIG. 3 is described in detail with reference to FIG. 8.

FIG. 8 shows the system diagram of the relative scale adjustment process 800 performed by the relative scale adjustment module 350 between two rectified ground planes output by the fixed-scale ground plane rectification modules 340 and 380. The input of the relative scale adjustment module 350 includes for each disjoint field of view an associated scene geometry. Each scene geometry includes the horizon line estimated by the horizon estimation steps 310, 360 (FIG. 3), the spatial properties of the camera including tilt angle estimated by the camera roll and tilt estimation steps 330, 380, and a statistical geometric property of moving objects in the scene 850. Please note that both horizon line and camera tilt are estimated based on the positions of moving objects in scene. So the only extra information required for determining the relative scaling factor between two rectified ground planes is the statistical geometric property of moving object in the scene 850.

The relative scale adjustment process 800 starts with a relative camera tilt estimation step 810. Denoting the tilt angles of camera 1 and camera 2 as θ₁ and θ₂, respectively, then relative camera tilt is defined as

$${r}_{θ} = \frac{cos {θ}_{1}}{cos {θ}_{2}} \qquad ( 23 )$$

Since the tilt angle for each camera is determined by the camera roll and tilt estimation steps 330, 380 based on Eqn (17), the value of this relative camera tilt is solvable.

The relative scale adjustment process 800 then moves on to a relative focal length is estimation step 810. Denoting the focal length of camera 1 and camera 2 as f₁ and f₂, respectively, then the relative focal length is defined as

$${r}_{f} = \frac{{f}_{1}}{{f}_{2}} \qquad ( 24 )$$

Based on Eqn (20), the focal length of the camera, fᵢ, is expressed in terms of its principal point yⁱₚ, its horizon position yₕⁱ, its tilt angle θᵢ, and its pixel aspect ratio αᵢ as follows

$${f}_{i} = {α}_{i} \frac{{y}_{p}^{i} - {y}_{h}^{i}}{cot {θ}_{i}} . \qquad ( 25 )$$

Without loss of generality, let us assume the two cameras 1000 are of the same type. This implies that α₁=α₂. By integrating this and Eqn (25) with Eqn (24), the relative focal length is given by:

$$\frac{{f}_{1}}{{f}_{2}} = \frac{{y}_{p}^{1} - {y}_{h}^{1}}{{y}_{p}^{2} - {y}_{h}^{2}} \cdot \frac{cot {θ}_{2}}{cot {θ}_{1}} . \qquad ( 26 )$$

noting that the superscript 1 and 2 in Equation (26) in, yₚ¹, yₚ², yₕ¹ and yₕ² indicates cameras 1 and 2 respectively.

Since the principal point of each FOV is assumed to be the centre of the image plane, and the horizon and the camera tilt have been estimated by the horizon estimation module steps 310, 360 and camera roll and tilt estimation module steps 330, 380, respectively. The value of the relative focal length is now determinable.

In a next step 830, the relative scale adjustment process 800 performs the estimation of relative camera height based on a statistical geometric property of moving objects in the scene 850. In one embodiment, the statistical geometric property used is the ratio of the height of an object in the image plane to its vertical position relative to the horizon line. Assuming that an object moves on the ground plane, it is known to those skilled in the relevant art that the height of the object in the image plane, h, has a linear relationship with the vertical position of the object in the image plane, yₐ, from the horizon position, yₕ, as approximated by:

h=γ(yₐ−yₕ), (27)

where γ is the slope of the linear approximation.

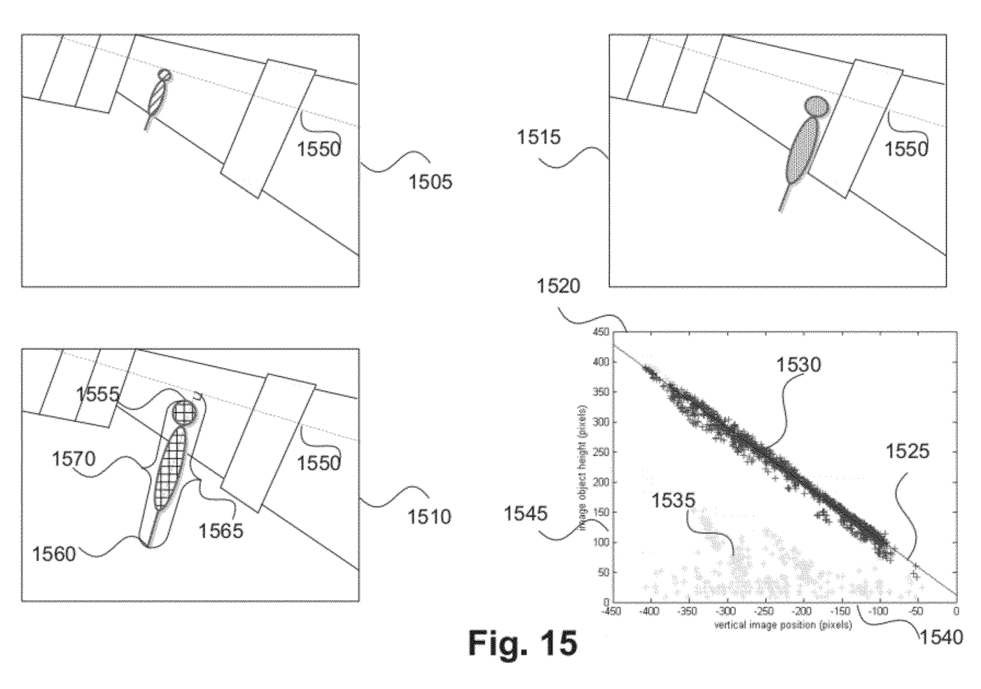

FIG. 15 shows an example scenario where several people with different heights are walking in a room within the FOV of camera 1 1100. Frames 1505, 1510 and 1515 are three observations by camera 1 1100. Taking frame 1510 as an example, at step 305 of the method 300, the head 1555 and feet positions 1560 of object 1570 are determined, and the height of object 1570 (h in equation 27) in the image is estimated by the distance between the head position 1555 and feet position 1510 of object 1570. At step 310 the position of the horizontal vanishing line 1550 is determined, and thus the vertical image position, that is, distance 1565 ((yₐ−yₕ) in Equation (27)) from the feet position 1560 of object 1570 to the horizontal vanishing line 1550 can be determined. Therefore, a point 1530 with x-coordinate the distance 1565 and y-coordinate height of 1570 in the image can be plotted in a graph 1520, which has the vertical image position 1540 in the x-axis and image object height 1545 in the y-axis. Graph 1520 collects the vertical image position in relation to the image object height points (black crosses and grey crosses) in all the frames where there are objects detected in step 310. A line 1525 can be fitted to the black crosses, which shows that the vertical image position ((yₐ−yₕ) in equation (27)) is linearly related to the image object height (h in equation (27)). The coefficient γ is the slope of line 1525. A point in black cross means the vertical image position and image object height in the corresponding frame for the corresponding object fit the linear relationship given in Eqn (27). A point in grey cross means the vertical image position and image object height in the corresponding frame for the corresponding object does not fit the linear relationship given in equation (27). This is mainly due to some slight error in detecting the boundaries of the object in the object detection in step 310. Another example of the misdetection is that an object is split erroneously into two objects. Based on this linear relationship, a person skilled in the relevant art expresses the relationship between the camera height L and the object height H based on Eqn (27) as

$${sin}^{2} θ = \frac{γ}{H} \frac{L - H}{1 - γ} , \qquad ( 28 )$$

where θ is the tilt angle of the camera, which is estimated by the camera roll and tilt estimation module 330, 380 of FIG. 3. Without loss of generality, under the assumption is that the same object moves through both disjoint FOVs, the relative camera height is described with respect to the camera tilt and γ as follows:

$${r}_{L} = \frac{{L}_{1}}{{L}_{2}} = \frac{( 1 / {γ}_{1} - 1 ) {sin}^{2} {θ}_{1} + 1}{( 1 / {γ}_{2} - 1 ) {sin}^{2} {θ}_{2} + 1} , \qquad ( 29 )$$

where γ₁ and γ₂ is the ratio of the object height in the image and its vertical position in the image plane relative to the horizon line as modelled by Eqn (27) for each of the FOVs, respectively. Values for γ₁ and γ₂ can be determined by line fitting of object height and vertical position information from object tracking data for each FOV.

In the case where multiple objects move across both FOVs, the relative camera height is still determinable based on Eqn (29) as long as the moving object in both cameras 1000 belongs to the same category (such as people, vehicle, or large vehicle). This is because the γ value derived for a given camera view is relatively stable for moving objects that belong to the same category. Therefore, assuming the distribution of the object heights is similar in both views, Eqn (29) is used to determine the relative camera height.

In the last step 840, the relative scale adjustment process 800 computes the overall relative scaling factor between the two rectified ground planes output by the fixed-scale ground plane rectification module 340 and 390. The overall relative scaling factor, rₛ, is given by:

$${r}_{s} = \frac{{S}_{1}}{{S}_{2}} = \frac{{f}_{1}}{{f}_{2}} \cdot \frac{{L}_{2}}{{L}_{1}} \cdot \frac{cos {θ}_{1}}{cos {θ}_{2}} = {r}_{θ} {r}_{f} / {r}_{L} \qquad ( 30 )$$

The overall relative scaling factor rₛ is the final output of the relative scale adjustment process 800. This concludes the description of FIG. 8.

For cases with more than two cameras, a common ground plane can be established by computing relative scale factors for each camera relative to the ground plane of any one camera and then scaling as desired.

The track interpolation process performed by the track interpolation module 395 of FIG. 3 is described in detail with reference to FIG. 9.

FIG. 9 shows the system diagram of a track interpolation process 900. The input to the track interpolation process 900 includes the two rectified ground planes produced by the fixed-scale ground plane rectification module steps 340 and 390, and the relative scaling factor produced by the relative scale adjustment module step 380. The output of the track interpolation process 900 is a mosaic of rectified ground planes in a common coordinate frame containing the object trajectories from all of the disjoint FOVs.

The track interpolation processing 900 starts with a step 910, which adjusts the relative scale difference between two rectified ground planes with respect to each other based on the relative scaling factor output from the module 380. This adjustment puts the two rectified ground planes into a common coordinate frame representing a scaled version of the true ground.

Following the step 900 is a missing trajectory prediction step 920. The missing trajectory prediction step 920 predicts the missing object trajectory between the two disjoint FOVs in the common coordinate frame, based on the kinetic model of moving objects in the scene. In an exemplary embodiment, the kinetic models of moving objects on the ground plane are modelled as a first order-Markov dynamic contained by additive measuring noise. Therefore, the missing trajectories are predicted using a Kalman filter based on the previous track observation.

In a next step 930, the missed trajectories predicted by the Kalman filter are refined based on the observations of the object tracks in disjoint FOVs. In an exemplary embodiment, this refinement process is implemented by performing forward and backward track extrapolation from one FOV toward another FOV. In one embodiment, trajectories are sent from the IO interface 1008 of a first camera 1000 to the IO interface 1008 of a second camera 1000 through communications network 1014, and track interpolation is performed on the processor 1005 of the second camera 1000. In another embodiment, trajectories are sent from the IO interface 1008 of a first camera 1000 and from the IO interface 1008 of a second camera 1000 to a central server connected to the communications network 1014. The track interpolation is done on the central server, and results are sent back to the first and second cameras through the communications network 1014. The forward and backward extrapolation results are then averaged to produce the final missing trajectory. In an alternative embodiment, the missing trajectories between two disjoint FOV are estimated by finding the Maximum Posteriori Probable (MAP) tracks which fit the object kinetic model and track observations from both of the FOVs. The result of the missing trajectory refinement step includes the missing trajectories between the two disjoint FOVs, and the relative rotation and translation between the two disjoint FOVs.

In the last step 940, the track interpolation processing 900 performs view registration on the two rectified ground planes produced by the fixed-scale ground plane rectification module 340 and 390, based on the relative rotation and translation output from the step 930. The registration is known to be a homography based on the relative rotation and translation to a person skilled in the art. This concludes the detailed description of FIG. 9.

### INDUSTRIAL APPLICABILITY

The arrangements described are applicable to the computer and data processing industries and particularly for the imaging and surveillance industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of” Variations of the word “comprising”, such as “comprise” and “comprises” have correspondingly varied meanings.

The claims defining the invention are as follows:

1. A method of generating a common ground plane from a plurality of image sequences, each image sequence captured by a corresponding one of a plurality of cameras, said plurality of cameras having disjoint fields of view of a scene, said method comprising the steps of:
detecting at least three observations for each image sequence;
generating a plurality of rectified ground planes for the plurality of image sequences, said generation being based on a scene geometry and a spatial property of each corresponding camera determined from said detected observations in each of the image sequences;
determining a geometric property of the plurality of observations in the plurality of image sequences;
determining a relative scaling factor of each of said plurality of rectified ground planes, said relative scaling factor based on the geometric property of the plurality of objects in the images and the spatial property of each camera; and
generating the common ground plane from the plurality of image sequences based on said rectified ground planes and said determined relative scaling factors.

2. The method according to claim 1, comprising the further step of:
generating an overhead perspective view of said scene, based on said relative scaling factors of said common ground plane.

3. The method according to claim 1, further comprising a step of determining the scene geometry, wherein said step of determining the scene geometry comprises:
estimating a horizon of the scene; and
estimating a vertical vanishing point of the scene.

4. The method according to claim 3, wherein said step of determining the scene geometry is based on a set of predetermined features associated with the observations.

5. The method according to claim 3, wherein said step of determining the scene geometry comprises the steps of:
retrieving a set of track data of the plurality of observations;
linking a set of first features of the plurality of detected observations to produce a first line for the detected observations;
linking a set of second features of the plurality of detected observations to produce a second line for the detected observations; and determining an intersection point of at least the first line and the second line to be the vertical vanishing point of the scene.

6. The method according to claim 5, further comprising the step of:
linking a plurality of the vertical vanishing points of the scene to be the horizon of the scene.

7. The method according to claim 1, wherein the spatial property of each camera includes a camera roll angle and a camera tilt angle of the respective camera.

8. The method according to claim 1, wherein determining said geometric properties of the plurality of observations in the images of all cameras is based on a vertical position of the object in the image plane from the horizon position.

9. The method according to claim 1, wherein said observations relate to at least three detections of a single object in an image sequence or at least two detections of each of two objects in an image sequence.

10. A computer readable storage medium having recorded thereon a computer program for directing a processor to execute a method of generating a common ground plane from a plurality of image sequences, each image sequence captured by a corresponding one of a plurality of cameras, said plurality of cameras having disjoint fields of view of a scene, said computer program comprising code for performing the steps of:
detecting at least three observations for each image sequence;
generating a plurality of rectified ground planes for the plurality of image sequences, said generation being based on a scene geometry and a spatial property of each corresponding camera determined from said detected observations in each of the image sequences;
determining a geometric property of the plurality of observations in the plurality of image sequences;
determining a relative scaling factor of each of said plurality of rectified ground planes, said relative scaling factor based on the geometric property of the plurality of objects in the images and the spatial property associated with each camera; and
generating the common ground place from the plurality of image sequences based on said rectified ground planes and said determined relative scaling factors.

11. A multi-camera system comprising:
a plurality of cameras having disjoint fields of view of a scene, each camera having a lens system, an associated sensor, and a control module for controlling said lens system and said sensor to capture an image of said scene;
a storage device for storing a computer program; and
a processor for executing the program, said program comprising:
computer program code for generating a common ground plane from a plurality of image sequences captured by said plurality of cameras, each image sequence derived from one of said plurality of cameras, the generating including the steps of:
detecting at least three observations for each image sequence;
generating a plurality of rectified ground planes for the plurality of image sequences, said generation being based on a scene geometry and a spatial property of each corresponding camera determined from said detected observations in each of the image sequences;
determining a geometric property of the plurality of observations in the plurality of image sequences;
determining a relative scaling factor of each of said plurality of rectified ground planes, said relative scaling factor based on the geometric property of the plurality of objects in the images and the spatial property associated with each camera; and
generating the common ground plane from the plurality of image sequences based on said rectified ground planes and said determined relative scaling factors.

12. A multi-camera system comprising:
a plurality of cameras having disjoint fields of view of a scene, each camera having a lens system, an associated sensor, and a control module for controlling said lens system and said sensor to capture a respective image sequence of said scene;
a computer server coupled to each of said plurality of cameras, said server including:
a storage device for storing a computer program; and
a processor for executing the program, said program comprising:
computer program code for generating a common ground plane from a plurality of image sequences captured by said plurality of cameras, each image sequence derived from one of said plurality of cameras, the generating including the steps of:
detecting at least three observations for each image sequence;
generating a plurality of rectified ground planes for the plurality of image sequences, said generation being based on a scene geometry and a spatial property of each corresponding camera determined from said detected observations in each of the image sequences;
determining a geometric property of the plurality of observations in the plurality of image sequences;
determining a relative scaling factor of each of said plurality of rectified ground planes, said relative scaling factor based on the geometric property of the plurality of objects in the images and the spatial property associated with each camera; and
generating the common ground plane from the plurality of image sequences based on said rectified ground planes and said determined relative scaling factors.
